(19) United States
(12) Patent Application Publication
(10) Pub. No.: US 2026/0213917 A1
(43) Pub. Date: Jul. 23, 2026

(54) First Node, Second Node, Third Node, Fourth Node and Methods Performed Thereby for Handling Registration of the Second Node

(71) Applicant: Telefonaktiebolaget LM Ericsson (publ), Stockholm (SE)

(72) Inventors: Maria Pilar Benito Diez, Madrid (ES); Maria del Prado Paz, Madrid (ES)

(21) Appl. No.: 19/121,302

(22) PCT Filed: Dec. 21, 2022
(86) PCT No.: PCT/EP2022/087291

§ 371 Date: Apr. 15, 2025

(30) Foreign Application Priority Data
Nov. 3, 2022 (EP) 22383058.9

(51) Int. Cl. H04L 9/00; H04L 9/32; H04L 41/0806

(52) U.S. Cl. CPC H04L 9/006; H04L 9/3228; H04L 9/3268; H04L 41/0806

(57) ABSTRACT

A method by a first node (111) in a communications system (100), for handling registration of a second node (112). The first node (111) obtains (201) information from a third node (113) enabling to identify the second node (112). The second node (112) is expected to operate in the communications system (100). The first node (111) receives (205) a first request from the second node (112) indicating the information. The first node (111) determines (206), based on the obtained information and the information of the first request, whether the second node (112) is a node expected to operate in the communication system (100). The first node (111) sends (207), based on the determination, a second request to a fourth node (114) operating as a PKI-RA. The second request is to register the second node (112), so that a later request for processing of a certificate from the second node (112) is accepted.

### TECHNICAL FIELD

The present disclosure relates generally to a first node and methods performed thereby for handling registration of a second node. The present disclosure also relates generally to the second node, and methods performed thereby for handling the registration of the second node. The present disclosure further relates generally to a third node, and methods performed thereby for handling the registration of the second node. The present disclosure additionally relates generally to a fourth node, and methods performed thereby for handling the registration of the second node.

### BACKGROUND

Computer systems in a communications network or communications system may comprise one or more nodes. A node may comprise processing circuitry which, together with computer program code may perform different functions and actions, a memory, a receiving port, and a sending port. A node may be, for example, a server. Nodes may perform their functions entirely on the cloud.

The communications system may cover a geographical area which may be divided into cell areas, each cell area being served by a type of node, a network node in the Radio Access Network (RAN), radio network node or Transmission Point (TP), for example, an access node such as a Base Station (BS), e.g., a Radio Base Station (RBS), which sometimes may be referred to as e.g., gNB, evolved Node B (“eNB”), “eNodeB”, “NodeB”, “B node”, or Base Transceiver Station (BTS), depending on the technology and terminology used. The base stations may be of different classes such as e.g., Wide Area Base Stations, Medium Range Base Stations, Local Area Base Stations and Home Base Stations, based on transmission power and thereby also cell size. A cell may be understood to be the geographical area where radio coverage may be provided by the base station at a base station site. One base station, situated on the base station site, may serve one or several cells. Further, each base station may support one or several communication technologies. The telecommunications network may also comprise network nodes which may serve receiving nodes, such as user equipments, with serving beams.

The standardization organization Third Generation Partnership Project (3GPP) is currently in the process of specifying a New Radio Interface called Next Generation Radio or New Radio (NR) or 5G-Universal Terrestrial Radio Access (UTRA), as well as a Fifth Generation (5G) Packet Core Network, which may be referred to as 5G Core Network (5GC), abbreviated as 5GC.

### Transport Layer Security (TLS)

TLS may be understood to be a cryptographic protocol designed to provide security in communications over a computer network. TLS may be understood to provide server authentication. Client authentication may be understood to be optional. To provide server authentication may be understood to mean to enable to check that the communication may be being established towards the correct server. TLS may also provide confidentiality. This may be understood to mean that the data transmitted may be encrypted, usually with symmetric encryption, although a private key may be needed to be shared between client and server using an asymmetric protocol. TLS may further provide integrity, meaning that it may be able to ensure that the data may not have been changed during the transmission.

When the protocol also provides client authentication it may be referred to as mutual authentication or mutual TLS (mTLS).

The protocol may be widely used in applications such as email, instant messaging, and voice over Internet Protocol (IP), but its use in securing Hypertext Transfer Protocol (HTTP) remains the most publicly visible.

TLS may normally use digital certificates for the end entities involved in the communication. A certificate may be understood as a binding of a public key to an entity made by a Certificate Authority (CA). Therefore, it may also require the presence of a Public Key Infrastructure (PKI) with the participation of a CA and optionally, a Registration Authority (RA). Each of these is described next.

### Public Key Infrastructure (PKI)

A PKI may be understood to be a set of roles, policies, hardware, software, and procedures that may be needed to create, manage, distribute, use, store and revoke digital certificates and manage public-key encryption.

In cryptography, a PKI may be understood to be an arrangement that may bind public keys with respective identities of entities, such as people and organizations.

The binding may be established through a process of registration and issuance of certificates. The process of binding may be done manually or by an automated process, following a certificate management protocol such as Certificate Management Protocol version 2(CMPv2 ).

A Certificate Signing Request (CSR) may be understood to be a message sent from an applicant to a PKI to apply for a digital identity certificate. It may usually contain the public key for which the certificate may need to be issued, and information identifying the applicant, such as a domain name or a distinguished name.

### Registration Authority (RA)

An RA may be understood to be a software which may inspect certificate requests from nodes. If found correct, meaning that the entity requesting the certificate is known by the RA through the use of some kind of credentials shared with the RA, the request may be forwarded to the CA. RA may be understood to be an optional function in the PKI system.

The Internet Engineering Task Force's RFC 3647 defines an RA as an entity that may be responsible for one or more of the following functions: the identification and authentication of certificate applicants, the approval or rejection of certificate applications, initiating certificate revocations or suspensions under certain circumstances, processing subscriber requests to revoke or suspend their certificates, and approving or rejecting requests by subscribers to renew or re-key their certificates. RAs, however, may be understood to not sign or issue certificates. To sign a certificate may be understood as a procedure performed by a CA which may comprise generating a hash of a document where data related to the entity that may identify the certificate may be understood to be described. Then, the CA may encrypt this hash with its own private key and attach it to the certificate, together with the identity of the CA that may be signing the certificate as issuer. That is, an RA may be delegated certain tasks on behalf of a CA.

### Certificate Authority (CA)

A CA may be understood to be a trusted software which may issue certificates inside a PKI.

### Service Base Interface (SBI)

In 5G Core, the SBI may be understood to be the name given to the REST Application Programming Interface (API) based communication between Network Functions (NFs) deployed in the 5G Control Plane following the 5G Service Based Architecture (SBA). 3GPP Technical Specification (TS) 23.501 v. 16.13.0 may be understood to define the 5G System Architecture as an SBA, that is, a system architecture in which the system functionality may be achieved by a set of NFs providing services to other authorized NFs to access their services. 3GPP TS 33.501 v. 17.5.0 may be understood to require TLS to protect data at the transport layer in the communication between NFs in the BSI. Network functions may be required to support both server-side and client-side certificates, although it may be understood to be up to the operator to decide whether to enable or not the cryptographic protection.

### Network Repository Function (NRF)

In the 5G SBA, the Network Repository Function (NRF) may be understood to be a new entity that may appear in the 5G Core System Architecture and may be defined in 3GPP as the network function responsible for maintaining the Network Function (NF) profile of each NF instance deployed on the network, for allowing other NF instances to subscribe to, and get notified about, the registration in NRF of new NF instances of a given type and interested NF profile change, and for supporting service discovery function, by receipt of discovery requests from NF instances and detail which NF instances may support specific services.

When referring to SBI, the NRF may be understood to play the role of the authorization server.

Compliance with the requirements of TLS according to existing methods may be cumbersome and complex, and/or it may lead to misconfiguration. This may involve high overhead and usage of resources and impair the effective functioning of the communications network involved.

### SUMMARY

As part of the development of embodiments herein, one or more challenges with the existing technology will first be identified and discussed.

A first challenge that has been identified are the problems with manual registration. As mentioned above, 3GPP TS 33.501 v. 17.5.0 may require TLS to protect data at the transport layer in the communication between NFs in SBI. To do this, the so-called end entity certificates may be required to be provisioned in the NFs involved in the SBI, and these certificates may need to be provided by the PKI of the customer network, all this before the NF may register in the NRF. While there may be several protocols to get automatic enrolment of certificates as CMPv2, SCEP or others, the first step of registering the NF, that is, the end entity, in the PKI through the RA function is manual, and makes mTLS activation in the network cumbersome and complex, first for the number of certificates required, and second due to the fact that the 5G Core SBA may be understood to be designed for dynamic evolution, so that new NF instances may be added without impact to existing control plane NFs.

A second challenge that has been identified are the problems to trust NFs that appear in the network. PKI/CA may be understood to provide the trust anchor for NF communication through the certificates provided. All NFs involved in the SBI may be understood to need to trust the same rootCA. Today, TLS may be activated in the network per node, and there is no visibility and coordination on what CA may be trusted per node. This may lead on misconfiguration or having different trust anchors on the network. It may therefore be desirable that a central entity coordinates what CAs may be used and coordinate that in all NFs.

In summary, the number of certificates that may be needed in a 5GC SBI to ensure data protection at transport is high and dynamic in its nature, given that 5GC SBA may be understood to have been designed to be extended and adapt to network needs seamlessly.

Manual registration of NFs in the PKI of the operator limits the TLS network setup and dynamic network evolution.

According to the foregoing, it is an object of embodiments herein to improve the handling registration of a second node in a communications system.

According to a first aspect of embodiments herein, the object is achieved by a computer-implemented method, performed by a first node. The method is for handling registration of a second node. The first node operates in a communications system. The first node obtains information enabling to identify the second node. The second node is expected to operate in the communications system. The obtaining of the information is from a third node operating in the communications system. The first node receives, after having obtained the information, a first request from the second node, the first request indicating the information. The first node determines, responsive to the received first request and based on the obtained information and the information of the first request, whether or not the second node is a node which is expected to operate in the communication system. The first node then sends, based on a result of the determination, a second request to a fourth node. The fourth node operates for the communications system as a PKI RA. The second request is to register the second node, so that a later request for processing of a certificate from the second node is accepted.

According to a second aspect of embodiments herein, the object is achieved by a computer-implemented method, performed by the second node. The method is for handling the registration of the second node. The second node is expected to operate in the communications system. The second node obtains the information enabling to identify the second node in the communications system. The second node also sends, after having obtained the information, the first request to the first node operating in the communications system. The first request indicates the information. The second node receives, responsive to the sent first request and based on the obtained information, the second response from the first node. The second response indicates the registration of the second node at the fourth node operating for the communications system, so that a later request for processing of a certificate from the second node is accepted

According to a third aspect of embodiments herein, the object is achieved by a computer-implemented method, performed by the third node. The method is for handling the registration of the second node. The third node operates with the communications system or is comprised in the communications system. The third node provides the information enabling to identify the second node expected to operate in the communications system. The providing of the information is to the first node operating in the communications system. The third node also provides, to the first node, a fourth indication. The fourth indication indicates the fourth node operating for the communications system as a PKI RA, thereby enabling the first node to, with the information and the fourth indication, request the fourth node to register the second node, so that a later request for processing of a certificate from the second node is accepted.

According to a fourth aspect of embodiments herein, the object is achieved by a computer-implemented method, performed by a fourth node. The method is for handling the registration of the second node. The second node is expected to operate in the communications system. The fourth node operates in the communications system as a PKI RA. The fourth node receives a second request from the first node operating in the communications system. The second request is to register the second node, so that later requests for processing of a certificate from the second node are accepted. The second request comprises the information enabling to identify the second node in the communications system. The fourth node then sends, responsive to the received second request, the first response to the first node. The first response indicates the registration of the second node at the fourth node.

According to a fifth aspect of embodiments herein, the object is achieved by the first node, for handling the registration of the second node. The first node is configured to operate in the communications system. The first node is further configured to obtain the information configured to enable to identify the second node. The second node is configured to be expected to operate in the communications system. The obtaining of the information is configured to be from the third node configured to be operating in the communications system. The first node is further configured to receive, after having obtained the information, the first request from the second node. The first request is configured to indicate the information. The first node is also configured to determine, responsive to the first request configured to be received and based on the information configured to be obtained and the information of the first request, whether or not the second node is a node which is expected to operate in the communication system. The first node is further configured to send, based on the result of the determination, the second request to the fourth node. The fourth node is configured to operate for the communications system as a PKI RA. The second request is configured to be to register the second node so that a later request for processing of a certificate from the second node is accepted.

According to a sixth aspect of embodiments herein, the object is achieved by the second node, for handling the registration of the second node. The second node is configured to be expected to operate in the communications system. The second node is further configured to obtain the information configured to enable to identify the second node in the communications system. The second node is further configured to send, after having obtained the information, the first request to the first node configured to operate in the communications system. The first request is configured to indicate the information. The second node is further configured to receive, responsive to the first request configured to be sent and based on the information configured to be obtained, the second response from the first node. The second response is configured to indicate the registration of the second node at the fourth node configured to operate for the communications system, so that a later request for processing of a certificate from the second node is accepted.

According to a seventh aspect of embodiments herein, the object is achieved by the third node, for handling the registration of the second node. The third node is configured to operate in the communications system or to be comprised in the communications system. The third node is further configured to provide the information configured to enable to identify the second node configured to be expected to operate in the communications system. The providing of the information is to the first node configured to operate in the communications system. The third node is further configured to provide, to the first node, the fourth indication. The fourth indication is configured to indicate the fourth node configured to operate for the communications system as a PKI RA, thereby being configured to enable the first node to, with the information and the fourth indication, request the fourth node to register the second node, so that a later request for processing of a certificate from the second node is accepted.

According to an eighth aspect of embodiments herein, the object is achieved by the fourth node, for handling the registration of the second node. The second node is configured to be expected to operate in the communications system. The fourth node is configured to operate in the communications system as a PKI RA. The fourth node is further configured to receive the second request from the first node configured to operate in the communications system. The second request is configured to be to register the second node, so that later requests for processing of a certificate from the second node are accepted. The second request is configured to comprise the information configured to enable to identify the second node in the communications system. The fourth node is further configured to send, responsive to the received second request, the first response to the first node. The first response is configured to indicate the registration of the second node at the fourth node.

By obtaining the information from the third node and then receiving the first request indicating the information from the second node, the first node may be enabled to determine, responsive to the received first request and based on the obtained information and the information of the first request, whether or not the second node is a node which is expected to operate in the communication system, that is, to verify, upon receiving the first request from the second node to, whether or not the second node is a trusted and expected network function.

By sending the second request based on the result of the determination, the first node may thereby enable an automatic registration of each network function such as the second node, towards the fourth node, a Registration Authority in a PKI infrastructure, as a previous step for a fifth node e.g., a Certificate Authority, to issue certificates, in a trusted way. This may in turn enable an operator deploying core architecture in the communications system, e.g., 5G core architecture, to add a new step to the path of a fully automatic and trusted environment, avoiding manual intervention. According to embodiments herein, the provisioning of the second node in the first node may allow to check if the second node to be registered may be known by the operator, avoiding the instantiation and registration in the network of malicious NFs. The first node may therefore be enabled to increase its role as security anchor, acting as a proxy towards the fourth node, a registration authority in the network operator.

By obtaining the information, and then sending the first request indicating the information to the first node, the second node may enable the first node to verify, upon receiving any future request from the second node to, whether or not the second node is a trusted and expected network function, and if validated as such, register it with the fourth node, the operator's PKI Registration Authority, as described earlier.

By receiving the second response with the identifier of the fourth node and the OTP in, the second node may be enabled to store the identifier of the fourth node for enrollment of the certificates together with the OTP to access to the fourth node.

By providing the information to the first node, the third node may enable the first node to verify, upon receiving any future request from the second node to, whether or not the second node may be a trusted and expected network function, and if validated as such, register it with the fourth node.

By providing the fourth indication to the first node indicating the fourth node, the third node may enable the first node to in turn provide this information to the second node, after having verified that the second node is a trusted and expected network function, so that the second node may then register with the fourth node, using the fourth indication.

By receiving the second request from the first node, the first node may enable an automatic registration of each network function such as the second node, towards the fourth node as a previous step for the fifth node, e.g., the Certificate Authority, to issue certificates, in a trusted way, avoiding manual intervention. By sending the second request based on the result of the determination of Action, the first node may allow to check if the second node to be registered is known by the operator, avoiding the instantiation and registration in the network of malicious NFs.

By sending the first response with the identifier of the fourth node and the OTP, the fourth node may enable the first node to provide the identifier and the OTP to the second node, so it may then use the identifier and the OTP to access to the fourth node for enrollment of certificates.

### BRIEF DESCRIPTION OF THE DRAWINGS

Examples of embodiments herein are described in more detail with reference to the accompanying drawings, according to the following description.

FIG. 1 is a schematic diagram illustrating a non-limiting example of a communications system, according to embodiments herein.

FIG. 2 is a flowchart depicting embodiments of a method in a first node, according to embodiments herein.

FIG. 3 is a flowchart depicting embodiments of a method in a second node, according to embodiments herein.

FIG. 4 is a flowchart depicting embodiments of a method in a third node, according to embodiments herein.

FIG. 5 is a flowchart depicting embodiments of a method in a fourth node, according to embodiments herein.

FIG. 6 a schematic diagram depicting a high level non-limiting example of an architecture, according to embodiments herein.

FIG. 7 a schematic diagram depicting a detailed non-limiting example of an architecture, according to embodiments herein.

FIG. 8 is a schematic diagram depicting a non-limiting example of signalling between nodes in a communications system, according to embodiments herein.

FIG. 9 is a schematic diagram depicting another non-limiting example of signalling between nodes in a communications system, according to embodiments herein.

FIG. 10 is a schematic diagram depicting a non-limiting example of signalling between nodes in a communications system, according to embodiments herein.

FIG. 11 is a schematic diagram depicting another non-limiting example of signalling between nodes in a communications system, according to embodiments herein.

FIG. 12 is a schematic diagram depicting yet another non-limiting example of signalling between nodes in a communications system, according to embodiments herein.

FIG. 13 is a schematic diagram depicting a non-limiting example of signalling between nodes in a communications system, according to embodiments herein.

FIG. 14 is a schematic diagram depicting another non-limiting example of signalling between nodes in a communications system, according to embodiments herein.

FIG. 15 is a schematic diagram depicting yet another non-limiting example of signalling between nodes in a communications system, according to embodiments herein.

FIG. 16 is a schematic block diagram illustrating two non-limiting examples, a) and b), of a first node, according to embodiments herein.

FIG. 17 is a schematic block diagram illustrating two non-limiting examples, a) and b), of a second node, according to embodiments herein.

FIG. 18 is a schematic block diagram illustrating two non-limiting examples, a) and b), of a third node, according to embodiments herein.

FIG. 19 is a schematic block diagram illustrating two non-limiting examples, a) and b), of a fourth node, according to embodiments herein.

### DETAILED DESCRIPTION

Certain aspects of the present disclosure and their embodiments address one or more of the challenges identified with the existing methods and provide solutions to the challenges discussed.

Embodiments herein may relate to automatic registration in of a node in a communications system. Particular examples of embodiments herein may relate to automatic registration in a PKI RA for 5G NFs. Embodiments herein may use an NRF to register each NF in an RA in the PKI of an operator, prior to issuance of the certificates for the Service Base Interfaces (SBIs) in a 5G Core architecture. According to embodiments herein, the NRF may be provisioned with a respective NF instance identifier of each of the NFs that the operator may want to instantiate in its network, together with a key, to avoid having to impersonate the NF by “guessing” mechanisms of the Universal Unique Identifier (UUID) NF instance identifier. The NRF may also be provisioned with the data of the RA of the operator. Each NF may further be provisioned with a key which may have been generated by the Operations Support System (OSS). This may be the same key as that provisioned to the NRF. The NRF, upon NF request, may check the request, validate if the NF may have been already provisioned, and register the NF instance identifier in the RA.

The embodiments will now be described more fully hereinafter with reference to the accompanying drawings, in which examples are shown. In this section, embodiments herein are illustrated by exemplary embodiments. It should be noted that these embodiments are not mutually exclusive. Components from one embodiment or example may be tacitly assumed to be present in another embodiment or example and it will be obvious to a person skilled in the art how those components may be used in the other exemplary embodiments. All possible combinations are not described to simplify the description.

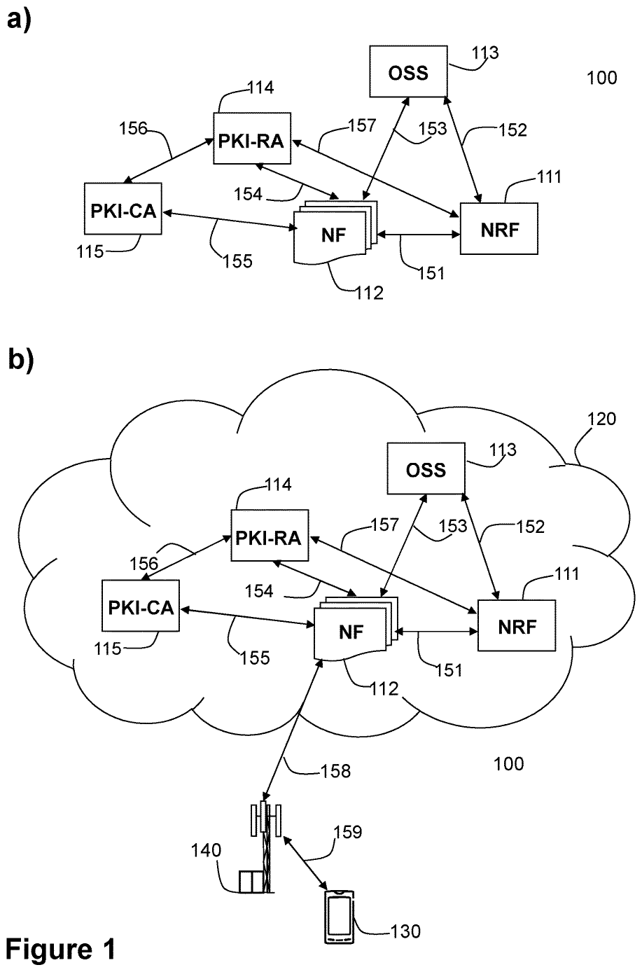

FIG. 1 depicts two non-limiting examples, in panels “a” and “b”, respectively, of a communications system 100, in which embodiments herein may be implemented. In some example implementations, such as that depicted in the non-limiting example of FIG. 1a, the communications system 100 may be a computer network. In other example implementations, such as that depicted in the non-limiting example of FIG. 1b, the communications system 100 may be implemented in a telecommunications system, sometimes also referred to as a telecommunications network, cellular radio system, cellular network, or wireless communications system. In some examples, the telecommunications system may comprise network nodes which may serve receiving nodes, such as wireless devices, with serving beams. The communications system 100 may for example be a network such as a 5G system, or a newer system supporting similar functionality. The telecommunications system may further support other technologies, such as a Long-Term Evolution (LTE) network, e.g., LTE Frequency Division Duplex (FDD), LTE Time Division Duplex (TDD), LTE Half-Duplex Frequency Division Duplex (HD-FDD), or LTE operating in an unlicensed band, Wideband Code Division Multiple Access (WCDMA), Universal Mobile Telecommunications System Terrestrial Radio Access (UTRA) TDD, Global System for Mobile communications (GSM) network, GSM/Enhanced Data Rate for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as IPv6 over Low-Power Wireless Personal Area Networks (6LowPAN), Zigbee, Z-Wave, Bluetooth Low Energy (BLE), or any cellular network or system. The telecommunications system may for example support a Low Power Wide Area Network (LPWAN). LPWAN technologies may comprise Long Range physical layer protocol (LoRa), Haystack, SigFox, LTE-M, and Narrow-Band IoT (NB-IoT).

The communications system 100 may comprise a plurality of nodes, and/or operate in communication with other nodes, whereof a first node 111, a second node 112, a third node 113, and a fourth node 114 are depicted in FIG. 1. The communications system 100 may comprise a plurality of second nodes such as the second node 112. In some embodiments, the communications system 100 may further comprise a fifth node 115, also depicted in FIG. 1. The first node 111, the second node 112 and the third node 113 are comprised in the communications system 100. The fourth node 114 and the fifth node 115 may operate for the communications system 100, e.g., it may be comprised in the communications system 100 or it may be external to the communications system 100. In some examples, the third node 113 may operate for the communications system 100. It may be understood that the communications system 100 may comprise more nodes than those represented on FIG. 1. Any of the first node 111, the second node 112, the third node 113, the fourth node 114 and the fifth node 115 may be understood, respectively, as a first computer system, a second computer system, a third computer system, a fourth computer system and a fifth computer system. In some examples, any of the first node 111, the second node 112, the third node 113, the fourth node 114 and the fifth node 115 may be implemented as a standalone server in e.g., a host computer in the cloud 120, as depicted in the non-limiting example depicted in panel b) of FIG. 1. Any of the first node 111, the second node 112, the third node 113, the fourth node 114 and the fifth node 115 may in some examples be a distributed node or distributed server, with some of their respective functions being implemented locally, e.g., by a client manager, and some of its functions implemented in the cloud 120, by e.g., a server manager. Yet in other examples, any of the first node 111, the second node 112, the third node 113, the fourth node 114 and the fifth node 115 may also be implemented as processing resources in a server farm.

Any of the first node 111, the second node 112, the third node 113, the fourth node 114 and the fifth node 115 may be independent and separate nodes. In some examples, any of the first node 111, the second node 112, the third node 113, the fourth node 114 and the fifth node 115 may be co-localized.

In some examples of embodiments herein, the first node 111 may be a node having a capability to store and maintain addresses for notifications registered by some nodes. In some particular examples wherein the communications system 100 may be a 5G network, the fourth node 114 may be an NRF operating in the communications system 100. This is depicted in the non-limiting example of FIG. 1 for illustrative purposes only.

The second node 112 may be a node that may have a capability to behave as a processing function in the communications system 100 and may have defined functional behavior and defined interfaces. In some embodiments, as in the non-limiting example of FIG. 1, the second node 112 may be a NF.

The third node 113 may be a node having a capability to enable a service provider to configure, monitor, control, analyze, and manage the communications system 100. In some particular examples, the third node 113 may be an OSS, e.g., in a 5G network.

The fourth node 114 may be a node having a capability to inspect certificate requests from nodes, and if found correct, to forward the request to the fifth node. The fourth node 114 may have a capability to identify and authenticate certificate applicants, approve or reject certificate applications, initiate certificate revocations or suspensions under certain circumstances, process subscriber requests to revoke or suspend their certificates, and approve or reject requests by subscribers to renew or re-key their certificates. The fourth node 114 may lack a capability to not sign or issue certificates. In some particular examples wherein the communications system 100 may be a 5G network, the fourth node 114 may be a PKI-RA operating in the communications system 100. This is depicted in the non-limiting example of FIG. 1 for illustrative purposes only.

The fifth node 115 may be a node having a capability to issue certificates, e.g., inside a PKI. In some particular examples, the fifth node 115 may be a PKI-CA, e.g., in a 5G network, as depicted in the non-limiting example of FIG. 1.

The communications system 100 may also comprise one or more devices, whereof a device 130 is represented in FIG. 1. It may be understood that the communications system 100 may comprise fewer or additional devices. The device 130 may be also known as e.g., user equipment (UE), a wireless device, mobile terminal, wireless terminal and/or mobile station, mobile telephone, cellular telephone, or laptop with wireless capability, an Internet of Things (IoT) device, a sensor, or a Customer Premises Equipment (CPE), just to mention some further examples. The device 130 in the present context may be, for example, portable, pocket-storable, hand-held, computer-comprised, or a vehicle-mounted mobile device, enabled to communicate voice and/or data, via a RAN, with another entity, such as a server, a laptop, a Personal Digital Assistant (PDA), or a tablet, a Machine-to-Machine (M2M) device, an Internet of Things (IoT) device, e.g., a sensor or a camera, a device equipped with a wireless interface, such as a printer or a file storage device, modem, Laptop Embedded Equipped (LEE), Laptop Mounted Equipment (LME), USB dongles or any other radio network unit capable of communicating over a radio link in the communications system 100. The device 130 may be wireless, i.e., it may be enabled to communicate wirelessly in the communications system 100 and, in some particular examples, may be able support beamforming transmission. The communication may be performed e.g., between two devices, between a device and a radio network node, and/or between a device and a server. The communication may be performed e.g., via a RAN and possibly one or more core networks, comprised, respectively, within the communications system 100.

The communications system 100 may comprise one or more radio network nodes, whereof a radio network node 140 is depicted in FIG. 1b. The radio network node 140 may typically be a base station or Transmission Point (TP), or any other network unit capable to serve a wireless device or a machine type node in the communications system 100. The radio network node 140 may be e.g., a 5G gNB, a 4G eNB, or a radio network node in an alternative 5G radio access technology, e.g., fixed or WiFi. The radio network node 140 may be e.g., a Wide Area Base Station, Medium Range Base Station, Local Area Base Station and Home Base Station, based on transmission power and thereby also coverage size. The radio network node 140 may be a stationary relay node or a mobile relay node. The radio network node 140 may support one or several communication technologies, and its name may depend on the technology and terminology used. The radio network node 140 may be directly connected to one or more networks and/or one or more core networks.

The communications system 100 covers a geographical area which may be divided into cell areas, wherein each cell area may be served by a radio network node, although, one radio network node may serve one or several cells.

The first node 111 may communicate with the second node 112 over a first link 151, e.g., a radio link or a wired link. The first node 111 may communicate with the third node 113 over a second link 152, e.g., a radio link or a wired link. The second node 112 may communicate with the third node 113 over a third link 153, e.g., a radio link or a wired link. The fourth node 114 may communicate with the second node 112 over a fourth link 154, e.g., a radio link or a wired link. The second node 112 may communicate, directly or indirectly, with the fifth node 115 over a fifth link 155, e.g., a radio link or a wired link. The fourth node 114 may communicate with the fifth node 115 over a sixth link 156, e.g., a radio link or a wired link. The fourth node 114 may communicate with the first node 111 over a seventh link 157, e.g., a radio link or a wired link. The radio network node 140 may communicate, directly or indirectly via the cloud 120, e.g., with one or more nodes comprised in the communications system 100, such as the second node 112, via an eighth link 158, e.g., a radio link or a wired link. The radio network node 140 may communicate with the device 130 over a ninth link 159, e.g., a radio link.

Any of the first link 151, the second link 152, the third link 153, the fourth link 154, the fifth link 155, the sixth link 156, the seventh link 157, the eighth link 158 and/or the ninth link 159 may be a direct link or it may go via one or more computer systems or one or more core networks in the communications system 100, or it may go via an optional intermediate network. The intermediate network may be one of, or a combination of more than one of, a public, private or hosted network; the intermediate network, if any, may be a backbone network or the Internet, which is not shown in FIG. 1.

Although terminology from Long Term Evolution (LTE)/5G has been used in this disclosure to exemplify the embodiments herein, this should not be seen as limiting the scope of the embodiments herein to only the aforementioned system. Other wireless systems supporting similar or equivalent functionality may also benefit from exploiting the ideas covered within this disclosure. In future telecommunication networks, e.g., in the sixth generation (6G), the terms used herein may need to be reinterpreted in view of possible terminology changes in future technologies.

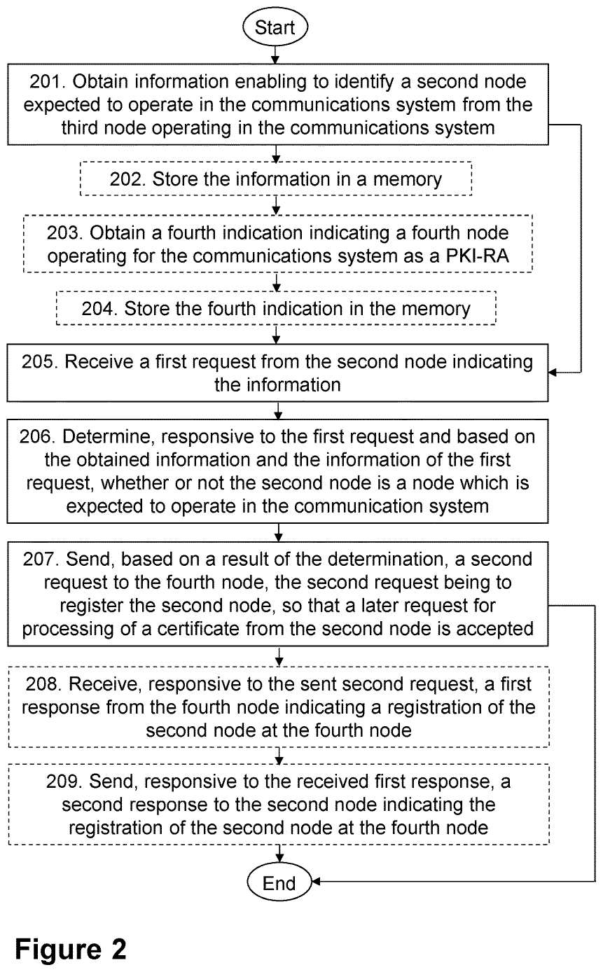

Embodiments of a computer-implemented method, performed by the first node 111, will now be described with reference to the flowchart depicted in FIG. 2. The method may be understood to be for handling registration of the second node 112. The first node 111 operates in the communications system 100.

In some embodiments, the communications system 100 may be a Fifth Generation, 5G, system.

The first node 111 may be an NRF node. In some examples, the first node 111 may be comprised in a 5G Control Plane Data Center.

The second node 112 may be an NF. The second node 112 may have a capability to automatically request certificates for a service-based interface of the second node 112.

Several embodiments are comprised herein. In some embodiments, all the actions may be performed. In other embodiments, some of the actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the first node 111 is depicted in FIG. 2. In FIG. 2, optional actions are represented with dashed lines.

### Action 201

According to embodiments herein, the first node 111 may be enabled to establish a new service for attending to requests performed by those second nodes, e.g., network functions, such as the second node 112, that may want to automatically enroll certificates for their service-based interface.

In this Action 201, the first node 111 first obtains information enabling to identify the second node 112. The second node 112 is expected to operate in the communications system 100. The obtaining in this Action 201 of the information is from the third node 113 operating in the communications system 100. That is, the third node 113, in this Action 201 may provision the first node 111 with information about expected NFs that may appear in the communications system 100, and one of those NFs may be the second node 112.

In some embodiments, the third node 113 may be an OSS node, e.g., the OSS of the Telecommunications Operator. In scenarios wherein the first node 111 may have just been instantiated in the network operator as the first node 111 for the control plane, and no other control plane 5G node may have been instantiated, the Telecommunications Operator may use the third node 113 to orchestrate the deployment and configuration of the first node 111. In such a scenario, the third node 113 may start provisioning the first node 111 with the data of the second node 112 and other NFs that may be deployed later in the communications system 100. The third node 113 may be comprised in an OSS Data Center of the communications system 100. The third node 113 may share the same data center as the 5G Control Plane Data Center or be hosted in a specific data center.

In some embodiments, the information may comprise a first indication identifying the second node 112. The first indication may univocally identify the second node 112. The first indication may be for example an NF instance identifier with, e.g., the format described in clause 5.3.2 of TS 29.571 v. 17.6.0 to univocally identify the second node 112. All second nodes, e.g., NFs, may be understood to be configured with a unique identifier, e.g., NF Instance Id. The operator of the communications system 100 may need to decide and coordinate the first indication, e.g., NF Instance Id, used in the communications system 100 using some Universally Unique IDentifier (UUID) generator utility in accordance with ISO/IEC 9834-8:2008, which may include RFC 4122, version 4, based on random UUID. The first indication, e.g. NF instance Id, may need to be safely stored and distributed by the operator to provisioning/configuration entities to assure that none may use non-intended identifiers, e.g., NF Instances Ids. The second indication, e.g., NF Key, provisioned in this Action 201 may be understood to help to avoid a malicious node deployed in the core network to guess the UUID and impersonate the real second node 112, e.g., an NF.

In some embodiments, the information may also comprise a second indication. The second indication may indicate a key assigned to the second node 112. The key may be a key to avoid impersonating of the second node 112, e.g., NF impersonating, in the environment. The key may be, for example, an NF key that may be used by the first node 111 to avoid the registration of malicious second nodes, e.g., NFs, that by any mechanism may guess the first indication, e.g., the NF instance id. This may be understood to introduce a more secure bootstrapping of the second nodes such as the second node 112.

In some embodiments, the information may further comprise a third indication. The third indication may indicate a type of the second node 112. The type of the second node 112 may be a network function type, for example, according to clause 6.1.6.3.3 of TS 29.510 v. 17.4.0, Authentication Server Function (AUSF), Unified Data Management (UDM), Unified Data Repository (UDR), etc.

Obtaining may comprise any of retrieving, fetching or receiving. The obtaining, e.g., receiving, of the information may be performed e.g., via the second link 152.

The obtaining in this Action 201 of the information may be via an encrypted interface It may be understood that there may be a plurality of second nodes that may be expected to operate in the communications system 100. The first node 111 may then repeat the same steps for each second node, e.g., NF.

By obtaining the information from the third node 113 in this Action 201, the first node 111 may then be enabled to verify, upon receiving any future request from the second node to 112, whether or not the second node 112 may be a trusted and expected network function, and if validated as such, register it with the fourth node 114, the operator's PKI Registration Authority, as will be described later.

### Action 202

In this Action 202, the first node 111 may store the obtained information in a memory of the first node 111, e.g., its database.

By storing the obtained information in the memory of the first node 111 in this Action 202, the first node 111 may then be able to use the obtained information when the second node 112 may be instantiated and registered into the first node 111. It may be understood that Action 201 and Action 202 may be repeated for each second node, e.g., network function, that may be expected in the communications system 100.

### Action 203

In this Action 203, the third node 113 may provision in the first node 111 the data about which PKI RA may be able to authenticate the entities requesting certificates in this communications system 100. That is, which PKI RA the second node 112 may need to connect to and the credentials that may be needed, to consider the first node 111 an authenticated and trusted entity. Accordingly, in this Action 203, the first node 111 may obtain a fourth indication from the third node 113. The fourth indication may indicate the fourth node 114. The fourth node 114 may be an RA node. The fourth indication may comprise credentials of the fourth node 114 and an identifier of the fourth node 114. The identifier of the fourth node 114 may be a uniform resource identifier (URI) of the fourth node 114.

The provisioning of the first node 111 may add any other information that may be needed to carry out the different activities performed by the first node 111.

The obtaining, e.g., receiving, of the information may be performed e.g., via the second link 152. The new service provided by the first node 111 used by the third node 113 to provision the NF Instance ID and the PKI RA data, may be performed through an encrypted interface of the third node 113.

By obtaining the fourth indication from the third node 113 indicating the fourth node 114, the first node 111 may then be enabled to provide this information to the second node 112, after having verified that the second node 112 is a trusted and expected network function, so that the second node 112 may then register with the fourth node 114, the operator's PKI Registration Authority, using the fourth indication.

### Action 204

In this Action 204, the first node 111 may store the obtained fourth indication in the memory of the first node 111.

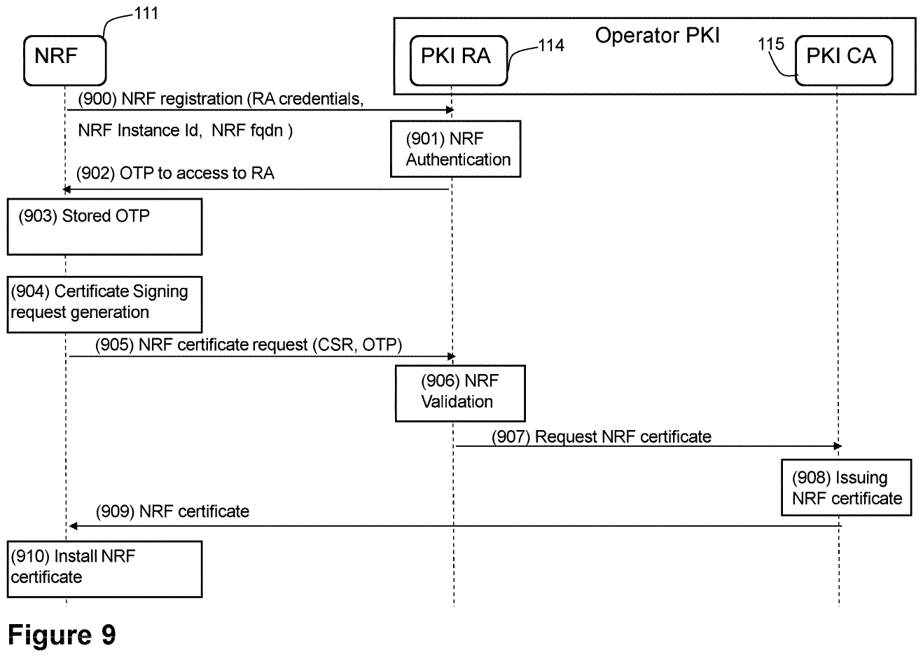

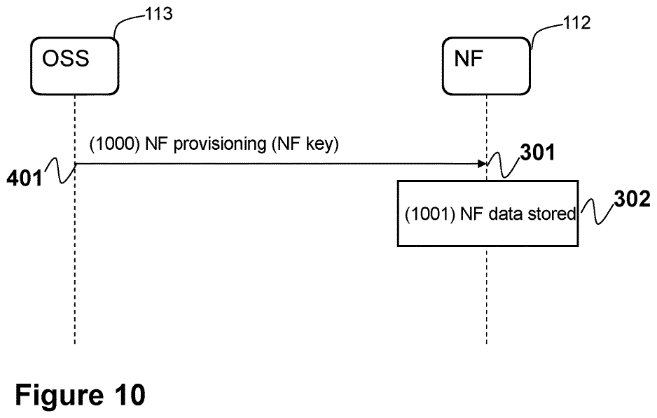

The first node 111 may store the data in this Action 204 that may be used for two purposes, firstly, to request its own certificates for the service base interfaces, as will be illustrated later in FIG. 9, and secondly, to register each second node 112, e.g., network function, as depicted in FIG. 10.

### Action 205

As mentioned above, the first node 111 may be enabled to establish a new service for attending the requests performed by those second nodes, e.g., network functions, such as the second node 112, that may want to automatically enroll certificates for their service-based interface.

In this Action 205, the first node 111 receives, after having obtained the information, a first request from the second node 112. The first request indicates the information.

When the second node 112 may connect to the first node 111, wherein the second node 112 may have the capability to automatically request certificates for its service-based interface, the second node 112 may, according to embodiments herein, perform the first request, which may be understood as a new request before the standardized Nnrf_NFMangementService operation NFRegister. This new request may be referred to herein “NF PKI Register Request”. Accordingly, the first request may be an NF PKI Register Request. If the second node 112 does not have the capability to automatically request certificates, then the second node 112 may be understood to not apply this new request, e.g., the NF PKI Register Request.

The information may therefore comprise the first indication, e.g., the network function instance identifier, with for example the format described in clause 5.3.2 of TS 29.571, V. 17.6.0, the NF Type, following the format defined in clause 6.1.6.3.3 of TS 29.510 v. 17.4.0, the second indication, e.g., the NF key provisioned by the third node 113 in Action 201 and, optionally, its Fully-Qualified Domain Name (FQDN). This may be understood to be a new service “NF PKI Register” offered by the first node 111 according to embodiments herein.

The receiving of the first request in this Action 205 may be performed e.g., via the first link 151. For attending to the first request and the requests performed by other second nodes, the first node 111 may open a server that may listen to requests in a secure way, e.g., by being protected with TLS, or in an unsecure way, e.g., in clear text. This implementation may be up to the first node 111 and afterwards, to the operator, to enable the TLS when the first node 111 may have this capability. It may be understood that this new service may be offered in a port that may not be protected with mutual TLS, since the second node 112, as other NF clients, may not yet be in possession of a client certificate. However, the service may be protected with TLS with a server certificate installed in the first node 111 during the configuration of the first node 111. In that case, the first indication identifying the second node 112, e.g., the NF Instance ID may not be able to be eavesdropped, since the traffic may be encrypted.

By receiving the first request indicating the information from the second node 112 in this Action 205, the first node 111 may be enabled to verify whether or not the second node 112 is a trusted and expected network function, and if validated as such, register it with the fourth node 114, the operator's PKI Registration Authority, as will be described later, in an automated fashion, thereby avoiding manual intervention except for the provisioning of the network functions in the first node 111, e.g., the NRF, that may be performed for different purposes.

### Action 206

In this Action 206, the first node 111 determines, responsive to the received first request and based on the obtained information and the information of the first request, whether or not the second node 112 is a node which is expected to operate in the communication system 100.

Determining may be understood as checking, calculating, deriving, matching, or similar. In some embodiments, that the first node 111 determines whether or not the second node 112 is a node which is expected to operate in the communication system 100 may comprise that the first node 111 may process the first request and validate or verify whether or not the second node 112 may be a trusted NF and expected by the network design, since in the provisioning time, the first indication, e.g., this NF Instance Identifier, may have been provisioned by the third node 113 in Action 201 and stored in the database of the first node 111 in Action 202. The first node 111 may then be enabled to validate in this Action 206, that the same first indication, e.g., NF Instance Id, third indication, e.g., NF Type and second indication, e.g., NF Key, that may have been provisioned in the first node 111 in Action 201 may match the first indication, e.g., NF Instance Id, sent in Action 205.

By determining, responsive to the received first request and based on the obtained information and the information of the first request, whether or not the second node 112 is a node which is expected to operate in the communication system 100 in this Action 206, the first node 111 may enable an automatic registration of each network function such as the second node 112, towards the fourth node 114, a Registration Authority in a PKI infrastructure, as a previous step for the fifth node 115, that is, a Certificate Authority, to issue certificates, in a trusted way. This may in turn enable the operator deploying core architecture in the communications system 100, e.g., 5G core architecture, to add a new step to the path of a fully automatic and trusted environment, avoiding manual intervention except for the provisioning of the network functions in the first node 111, e.g., the NRF, that may be performed for different purposes. According to embodiments herein, the provisioning of the second node 112 in the first node 111 may allow to check if the second node 112 to be registered is known by the operator, avoiding the instantiation and registration in the network of malicious NFs. The first node 111, e.g., the NRF, may therefore be enabled to increase its role as NF security anchor, acting as a proxy towards the fourth node 114, a registration authority in the network operator.

### Action 207

In this Action 207, the first node 111 sends, based on a result of the determination, a second request to the fourth node 114 operating for the communications system 100 as a PKI-RA. The second request is to register the second node 112, so that a later request for processing of a certificate from the second node 112 is accepted. The request for processing of the certificate may be a certificate signing request (CSR).

The second request may comprise the information.

That the sending in this Action 208 of the second request is based on the result of the determination, may comprise one of the following two options. In a first option, the sending in this Action 207 of the second request based on the result of the determination, may comprise sending the second request with the proviso the result of the determination is positive. That is, according to the first option, in case the received first indication, e.g., the network function instance identifier, is found in the database of the first node 111, matching also the third indication, e.g., the NF Type and the second indication, e. g, the NF key, stored with the third indication and the second indication received, the first node 111 may register the second node 112 in the fourth node 114, e.g., the operator's PKI Registration Authority, using the first indication, e.g., the NF instance identifier and, optionally, the FQDN of the second node 112. This request may also include the RA credentials, that may just be known by the first node 111 and not by the rest of the NFs in the network.

In a second option, that the sending in this Action 208 of the second request is based on the result of the determination, may comprise refraining from sending the second request and sending an alarm with the proviso the result of the determination is negative. That is, in case the information, e.g., the network function instance identifier plus the NF type and the NF key may not be found in the database of the first node 111, the operation may be rejected, sending the correspondent result to the second node 112. An alarm may additionally be raised to inform the operator, or service provider, that an error has occurred.

The first node 111 may obtain the fourth indication from the third node 113 in Action 203 prior to the sending of the second request.

The sending of the second request in this Action 207 may be performed e.g., via the seventh link 157.

By sending the second request in this Action 207 based on the result of the determination of Action 206, the first node 111 may enable an automatic registration of each network function such as the second node 112, towards the fourth node 114, a Registration Authority in a PKI infrastructure, as a previous step for the fifth node 115, that is, a Certificate Authority, to issue certificates, in a trusted way, avoiding manual intervention except for the provisioning of the network functions in the first node 111. By sending the second request based on the result of the determination of Action 206, the first node 111 may allow to check if the second node 112 to be registered is known by the operator, avoiding the instantiation and registration in the network of malicious NFs. The first node 111 may therefore be enabled to play a role as NF security anchor, acting as a proxy towards the fourth node 114, a registration authority in the network operator.

### Action 208

In this Action 208, the first node 111 may receive, responsive to the sent second request, a first response from the fourth node 114. The first response may indicate a registration of the second node 112 at the fourth node 114.

In response to receiving the second request, the fourth node 114 may have stored the information, that is, the network function data, in its database, and may have then generated a one-time password (OTP) to authenticate the second node 112. The fourth node 114 may then answer to the first node 111 with this OTP in this Action 208.

By receiving the first response with the OTP in this Action 208, the first node 111 may enable the registration of the second node 112 to happen automatically without the intervention of a manual operator or any other entity external to the communication system 100.

### Action 209

In this Action 209, the first node 111 may send, responsive to the received first response, a second response to the second node 112. The second response may indicate the registration of the second node 112 at the fourth node 114.

The second response may comprise the OTP, issued by the fourth node 114 and the identifier of the fourth node 114. As stated earlier, the identifier of the fourth node 114 may be, for example, the URI of the Registration Authority.

By sending the second response with the identifier of the fourth node 114 and the OTP in this Action 209, the first node 111 may enable the second node 112 to then store the identifier of the fourth node 114, e.g., the Registration Authority URI, for enrollment of the certificates together with the OTP to access to the fourth node 114.

After performing Action 209, the first node 111 may continue listening to new requests for other second nodes, e.g., other network functions.

It may be understood that using the service “NF PKI Register” in the first node 111 by the second node 112, a network function, does not mean that the second node 112 is registered in the communications system 100, that is, in the 5G network. Therefore, the first node 111 may not include this specific network function in the list of network functions registered, e.g., the service Nnrf_NFManagement operation NFListRetrieval, nor between the network functions that may be discovered by other network functions, e.g., the service Nnrf_NFDiscovery operation NFDiscover.

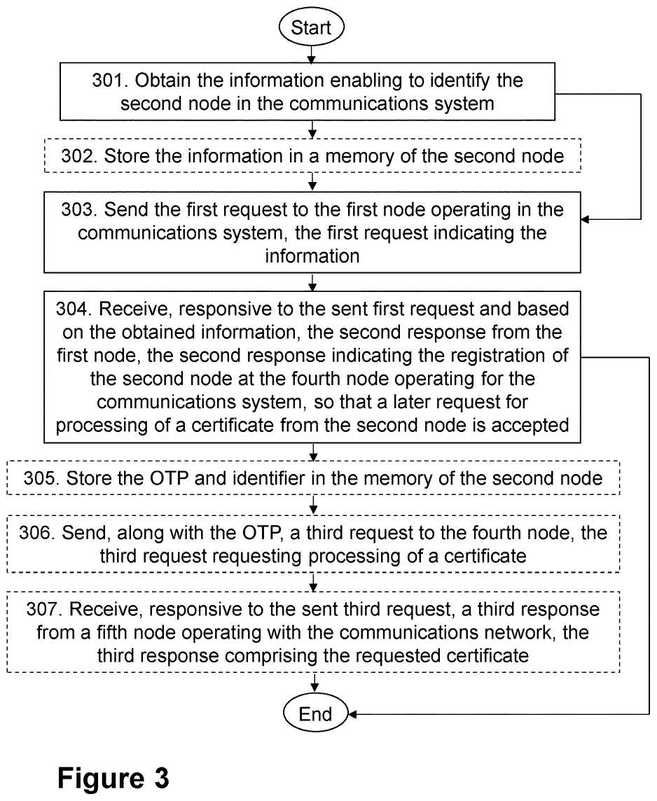

Embodiments of a computer-implemented method performed by the second node 112, will now be described with reference to the flowchart depicted in FIG. 3. The method may be understood to be for handling the registration of the second node 112. The second node 112 is expected to operate in the communications system 100.

In some embodiments, the communications system 100 may be a Fifth Generation, 5G, system.

Several embodiments are comprised herein. In some embodiments, all the actions may be performed. In other embodiments, some of the actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the second node 112 is depicted in FIG. 3. In FIG. 3, optional actions are depicted with dashed lines.

The detailed description of some of the following corresponds to the same references provided above, in relation to the actions described for the first node 111 and will thus not be repeated here to simplify the description. For example, in some embodiments, the second node 112 may be a NF. The second node 112 may have a capability to automatically request certificates for a service-based interface of the second node 112.

### Action 301

In this Action 301, the second node 112 obtains the information enabling to identify the second node 112 in the communications system 100.

The obtaining in this Action 201 of the information may be from the third node 113 operating in the communications system 100. The third node 113 may be an OSS node.

In some embodiments, the information may comprise the first indication identifying the second node 112.

In some embodiments, the information may also comprise the second indication indicating the key assigned to the second node 112. The third node 113 may provision, in this Action 301 in the second node 112 the same key that may have been previously provisioned in the first node 111 for the second node 112, that is, that NF.

In some embodiments, the information may further comprise the third indication indicating the type of the second node 112.

Obtaining may comprise any of retrieving, fetching or receiving.

The obtaining, e.g., receiving in this Action 301 may be performed e.g., via the third link 153. This Action 301 may be performed by the third node 113, or by any other mechanism during the bootstrapping of the second node 112, such as a secure configuration file or a variable environment. The obtaining in this Action 301 of the information may be via an encrypted interface.

In this Action 301, the provisioning of the second node 112 by the third node 113 may include some other parameters/values, e.g., as mentioned above, the first indication, e.g., the NF instance ID, the IP addresses for the interfaces, initial user credentials, etc.

By obtaining the information in this Action 301, the second node 112 may then be enabled to provide the information to the first node 111 and thereby enable the first node 111 to verify, upon receiving any future request from the second node to 112, whether or not the second node 112 is a trusted and expected network function, and if validated as such, register it with the fourth node 114, the operator's PKI Registration Authority, as described earlier.

### Action 302

In this Action 302, the second node 112 may store the obtained information in a memory of the second node 112.

### Action 303

In this Action 303, the second node 112 sends, after having obtained the information, the first request to the first node 111 operating in the communications system 100. The first request indicates the information. The first node 111 may be an NRF node. In some examples, the first node 111 may be comprised in a 5G Control Plane Data Center.

The first request may be the NF PKI Register Request.

The sending, e.g., receiving in this Action 303 may be performed e.g., via the first link 151.

By sending the first request indicating the information to the first node 111 in this Action 303, the first node 111 may be enabled to verify whether or not the second node 112 is a trusted and expected network function, and if validated as such, register it with the fourth node 114, as described earlier, in an automated fashion, thereby avoiding manual intervention.

### Action 304

In this Action 304, the second node 112 receives, responsive to the sent first request and based on the obtained information, the second response from the first node 111. The second response indicates the registration of the second node 112 at the fourth node 114 operating for the communications system 100, so that a later request for processing of a certificate from the second node 112 is accepted.

The request for processing of the certificate may be a CSR.

The second response may comprise the OTP, issued by the fourth node 114 and the identifier of the fourth node 114.

The fourth node 114 may be an RA node. In some embodiments, the second response may comprise the identifier of the fourth node 114, wherein the identifier of the fourth node 114 may be the URI of the fourth node 114.

The receiving in this Action 304 may be performed e.g., via the first link 151.

By receiving the second response with the identifier of the fourth node 114 and the OTP in this Action 304, the second node 112 may then be enabled to store the identifier of the fourth node 114 for enrollment of the certificates together with the OTP to access to the fourth node 114.

### Action 305

In this Action 305, the second node 112 may store the obtained OTP and identifier of the fourth node 114 in the memory of the second node 112.

### Action 306

Once the second node 112 may have received the second response from the first node 111, the second node 112 may initiate a process to get certificates for its service-based interface, client and server certificates. Firstly, the second node 112 may generate the private key and a third request, e.g., a CSR, including its own data, e.g., subject domain name, subject alternative name.

In this Action 306, the second node 112 may send, along with the OTP, the third request to the fourth node 114. The third request may request processing of a certificate. This third request may be sent to the fourth node 114, using the OTP and the URI that was previously stored in the second node 112 as an answer of the service “NF PKI Register” from the first node 111.

By sending the third request with the OTP in this Action 306, the second node 112 may enable the fourth node 114 to validate that this data may come from a trusted and previously registered entity, since it may have been registered in Action 207 through the OTP value provided, that may be understood to need to match with the one stored in the fourth node 114 for the second node 112. This may in turn enable the fourth node 114 to send the request to the fifth node 115, e.g., the certificate authority of the operator, e.g., PKI CA, which may then generate the certificate and send it to the second node 112, as described in the next Action 307.

### Action 307

In this Action 307, the second node 112 may receive, responsive to the sent third request, a third response from the fifth node 115 operating for the communications system 100. The third response may comprise the requested certificate. The fifth node 115 may be the PKI-CA.

By receiving the third response with the requested certificate in this Action 307, the second node 112 may then be enabled to install the certificate. With the certificate, e.g., mutual TLS may be enabled to encrypt the communications, as recommended by 3GPP.

The second node 112 may repeat the Actions 303-307 for each certificate that it may require, and for the renovation of the certificates when a certificate may be close to expiry, or when the certificate may have been revoked. It may be understood that the fourth node 114 may reject the operation if the second node 112 trying to get the certificate has not been registered previously.

After getting all the certificates, the usual bootstrapping process, as e.g., defined in 3GPP, may continue and the network function may register in the first node 111 performing the operation “NFRegister” provided by the service Nnrf_NFMangement in a secure way, using mutual TLS.

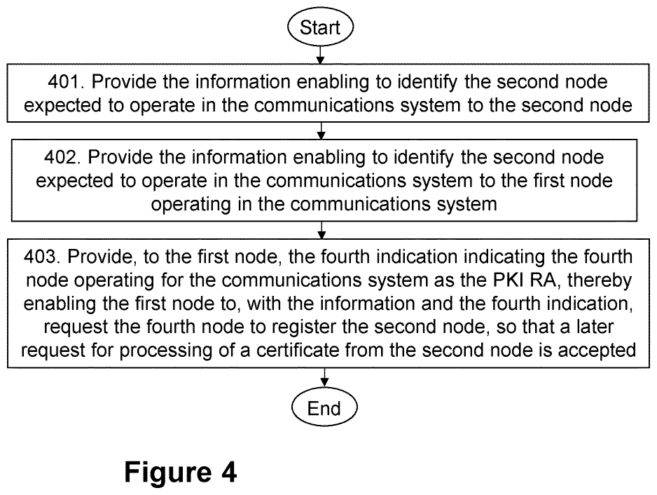

Embodiments of a computer-implemented method performed by the third node 113, will now be described with reference to the flowchart depicted in FIG. 4. The method may be understood to be for handling the registration of the second node 112. The third node 113 operates with the communications system 100 or is comprised in the communications system 100.

In some embodiments, the communications system 100 may be a Fifth Generation, 5G, system.

In some embodiments, the communications system 100 may be a Fifth Generation, 5G, system.

Several embodiments are comprised herein. The method comprises the following actions. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the third node 113 is depicted in FIG. 4. The detailed description of some of the following corresponds to the same references provided above, in relation to the actions described for the first node 111 and will thus not be repeated here to simplify the description. For example, in some embodiments, the third node 113 may be an OSS node.

Action 401 In this Action 401, the third node 113 may provide the information enabling to identify the second node 112. The second node 112 may be expected to operate in the communications system 100. The providing in this Action 401 of the information may be to the second node 112.

The second node 112 may be an NF.

The second node 112 may have the capability to automatically request certificates for a service-based interface of the second node 112.

In some embodiments, the information may comprise the first indication identifying the second node 112.

In some embodiments, the information may also comprise the second indication indicating the key assigned to the second node 112.

In some embodiments, the information may further comprise the third indication indicating the type of the second node 112.

Providing may comprise sending, e.g., via the third link 153.

The providing in this Action of the information may be via an encrypted interface.

By providing the information to the second node 112 in this Action 401, the third node 113 may then enable the first node 111 to verify, upon receiving any future request from the second node to 112, whether or not the second node 112 may be a trusted and expected network function, and if validated as such, register it with the fourth node 114, the operator's PKI Registration Authority, as described earlier.

### Action 402

In this Action 402, the third node 113 provides the information enabling to identify the second node 112 expected to operate in the communications system 100. The providing in this Action 402 of the information is to the first node 111 operating in the communications system 100.

The first node 111 may be an NRF node.

In some embodiments, the information may comprise the first indication identifying the second node 112.

In some embodiments, the information may also comprise the second indication indicating the key assigned to the second node 112.

In some embodiments, the information may further comprise the third indication indicating the type of the second node 112.

Providing may comprise sending, e.g., via the second link 152.

The providing in this Action of the information may be via an encrypted interface.

The providing in this Action 402 of the information to the first node 111 may further comprise providing the same information to the second node 112. For example, the third node 113 may provision, in this Action 402, the same key that it may have also provisioned in the second node 112 in Action 401.

By providing the information to the first node 111 in this Action 402, the third node 113 may then enable the first node 111 to verify, upon receiving any future request from the second node to 112, whether or not the second node 112 may be a trusted and expected network function, and if validated as such, register it with the fourth node 114, the operator's PKI Registration Authority, as described earlier.

### Action 403

The third node 113, in this Action 403, provides, to the first node 111, the fourth indication indicating the fourth node 114 operating for the communications system 100 as the PKI-RA. The fourth node 114 may be an RA node.

By providing the fourth indication to the first node 111 in this Action 403, the third node 113 may thereby enable the first node 111 to, with the information and the fourth indication, request the fourth node 114 to register the second node 112, so that a later request for processing of a certificate from the second node 112 is accepted.

The request for processing of the certificate may be a CSR.

The fourth indication may comprise the credentials of the fourth node 114 and the identifier of the fourth node 114. The identifier of the RA may be a uniform resource identifier (URI) of the fourth node 114.

By providing the fourth indication to the first node 111 indicating the fourth node 114, the third node 113 may then enable the first node 111 to in turn provide this information to the second node 112, after having verified that the second node 112 is a trusted and expected network function, so that the second node 112 may then register with the fourth node 114, the operator's PKI Registration Authority, using the fourth indication.

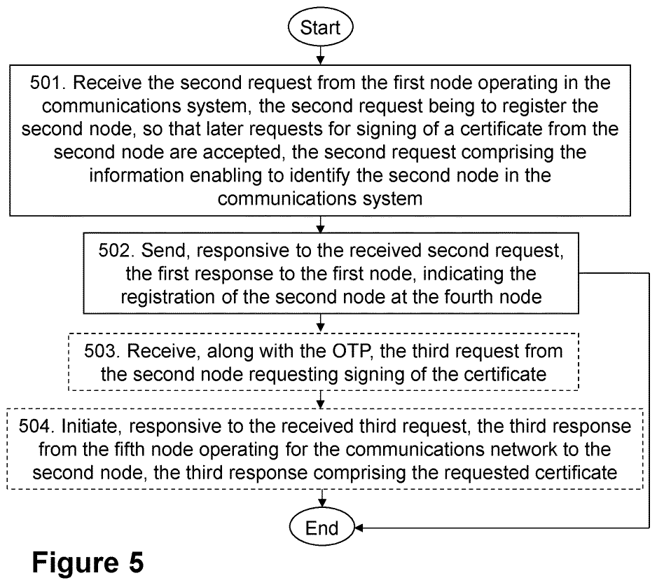

Embodiments of a computer-implemented method performed by the fourth node 114, will now be described with reference to the flowchart depicted in FIG. 5. The method may be understood to be for handling the registration the second node 112. The second node 112 is expected to operate in the communications system 100. The fourth node 114 operates for the communications system 100 as a Public Key Infrastructure, PKI-RA.

In some embodiments, the communications system 100 may be a Fifth Generation, 5G, system.

Several embodiments are comprised herein. In some embodiments, all the actions may be performed. In other embodiments, some of the actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the fourth node 114 is depicted in FIG. 5. In FIG. 5, optional actions are depicted with dashed lines.

The detailed description of some of the following corresponds to the same references provided above, in relation to the actions described for the first node 111 and will thus not be repeated here to simplify the description. For example, in some embodiments, the fourth node 114 may be an RA node.

### Action 501

In this Action 501, the fourth node 114 receives the second request from the first node 111 operating in the communications system 100. The second request is to register the second node 112, so that later requests for processing of a certificate from the second node 112 are accepted. The second request comprises the information enabling to identify the second node 112 in the communications system 100.

The request for processing of the certificate may be a CSR.

The first node 111 may be an NRF node.

The second node 112 may have the capability to automatically request certificates for a service-based interface of the second node 112. The second node 112 may be an NF.

In some embodiments, the information may comprise the first indication identifying the second node 112.

In some embodiments, the information may also comprise the second indication indicating the key assigned to the second node 112.

In some embodiments, the information may further comprise the third indication indicating the type of the second node 112.

The receiving in this Action 501 may be performed, e.g., via the seventh link 157.

By sending the second request in this Action 501 from the first node 111, the first node 111 may enable an automatic registration of each network function such as the second node 112, towards the fourth node 114, a Registration Authority in a PKI infrastructure, as a previous step for the fifth node 115, that is, a Certificate Authority, to issue certificates, in a trusted way, avoiding manual intervention except for the provisioning of the network functions in the first node 111. By sending the second request based on the result of the determination of Action 206, the first node 111 may allow to check if the second node 112 to be registered is known by the operator, avoiding the instantiation and registration in the network of malicious NFs.

### Action 502

The fourth node 114, in this Action 502, sends, responsive to the received second request, the first response to the first node 111. The first response indicates the registration of the second node 112 at the fourth node 114.

The first response may comprise the identifier of the fourth node 114. The identifier of the fourth node 114 may be the URI of the fourth node 114 In some embodiments, the first response may comprise the OTP issued by the fourth node 114, and the identifier of the fourth node 114.

By sending the first response with the identifier of the fourth node 114 and the OTP in this Action 502, the fourth node 114 may enable the first node 111 to provide the identifier and the OTP to the second node 112, so it may then use the identifier and the OTP to access to the fourth node 114 for enrollment of certificates.

### Action 503

In some embodiments wherein the first response may comprise the OTP issued by the fourth node 114, and the identifier of the fourth node 114, the fourth node 114 may then, in this Action 503, receive, along with the OTP, the third request from the second node 112. The third request may request signing of a certificate.

The receiving of the third request in this Action 503 may be performed e.g., via the fourth link 154.

By receiving the third request with the OTP in this Action 503 from the second node 112, the fourth node 114 may be enabled to validate that this data may come from a trusted and previously registered entity, since it may have been registered in Action 207 by the first node 111 through the OTP value provided. The OTP value may be understood to need to match with the one stored in the fourth node 114 for the second node 112. This may in turn enable the fourth node 114 to then send the third request to the fifth node 115, e.g., the certificate authority of the operator, e.g., PKI CA, which may then generate the certificate and send it to the second node 112.

### Action 504

In some embodiments wherein the first response may comprise the OTP issued by the fourth node 114, and the identifier of the fourth node 114, the fourth node 114 may then, in this Action 504, initiate, responsive to the received third request, the third response from the fifth node 115 operating for the communications system 100 to the second node 112. The third response may comprise the requested certificate. The fifth node 115 may be the PKI-CA.

Initiating may be understood as triggering, enabling or starting. The fourth node 114 may initiate the third response by sending the third request received from the second node 112 to the fifth node 115.

By initiating the response from the fifth node 115 in this Action 504, the fourth node 114 may enable that the second node 112 may receive the certificate from the fifth node 115 and may thereby be enabled to install the certificate.

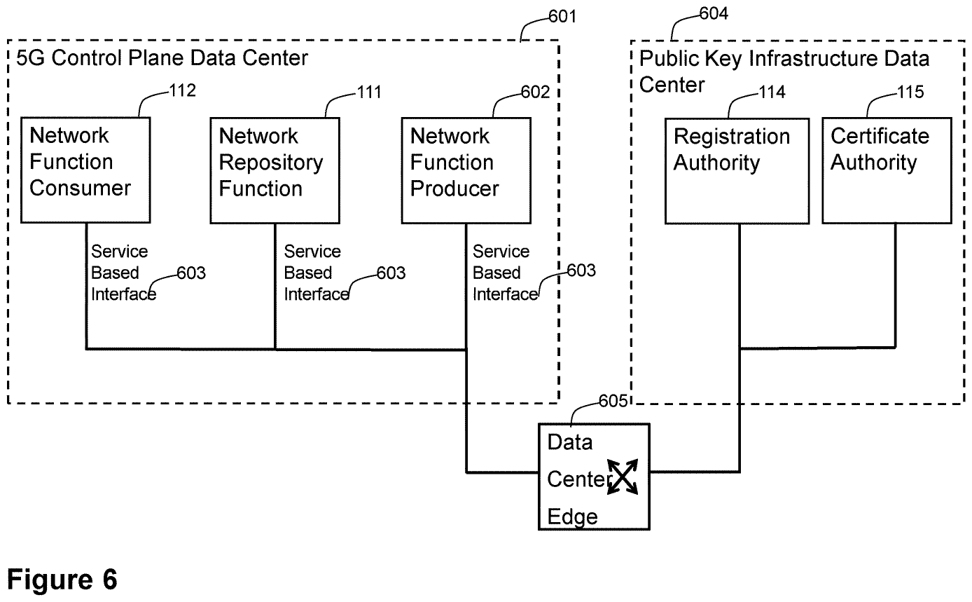

Several non-limiting examples of a method in the communications system 100 according to embodiments herein will now be described in the next FIGS. 6-15. In FIGS. 6-15, the communications system 100 is a 5G network, the first node 111 is an NRF, the second node 112 is a NF, the third node 113 is an OSS, the fourth node 114 is a PKI-RA and the fifth node 115 is a PKI-CA. It may be understood that in the following examples depicted in FIG. 6-15, any reference to the NRF may be understood to equally refer to the first node 111, any reference to the NF may be may be understood to equally refer to the second node 112, any reference to the OSS may be may be understood to equally refer to the third node 113, any reference to the PKI-RA may be may be understood to equally refer to the fourth node 114, and any reference to the PKI-CA may be may be understood to equally refer to the fifth node 115.

FIG. 6 is a schematic diagram depicting a high level non-limiting example of an architecture the communications system 100 may have, according to embodiments herein. The example of FIG. 6 depicts a Data Center 601, where 5G network functions in the control plane have been deployed. For the sake of simplicity, just one network function consumer, as an example of the second node 112, and one network function producer 602 have been shown. The network repository function (NRF), as an example of the first node 111, is already deployed in this Data Center 601, where the other two network functions have registered their respective profiles and have been subscribed to notifications of registration, deregistration and profile changes of other network functions instances located in the 5G Control Plane Data Center 601. The user plane functions may be in the same Data Center 601 or in another Data Center 601, not depicted here. Although the network functions may have more than one interface, for the simplicity of this description, just the service-based interface 603 is depicted. Outside the 5G Control Plane Data Center 601, there may be located another Data Center 604 that may host the Public Key Infrastructure of the operator. The Data Center 604 that may host the Public Key Infrastructure of the operator may comprise the fourth node 114, as a Registration Authority, which may accept the request for digital certificates and authenticate the entity making the request, and the fifth node 115, as a Certificate Authority, which may issue the certificates once they may have been validated and authenticated by the Registration Authority. These functions may also be located in the same data center 601 as the control plane network functions. It may be understood to be up to the service provider where the functions may be located. However, they have been depicted in different data centers to illustrate a security zoning separation common in telecommunications operators. Communication between the 5G control plane data center 601 and the public key infrastructure data center 604 may take place via a data center edge 605.

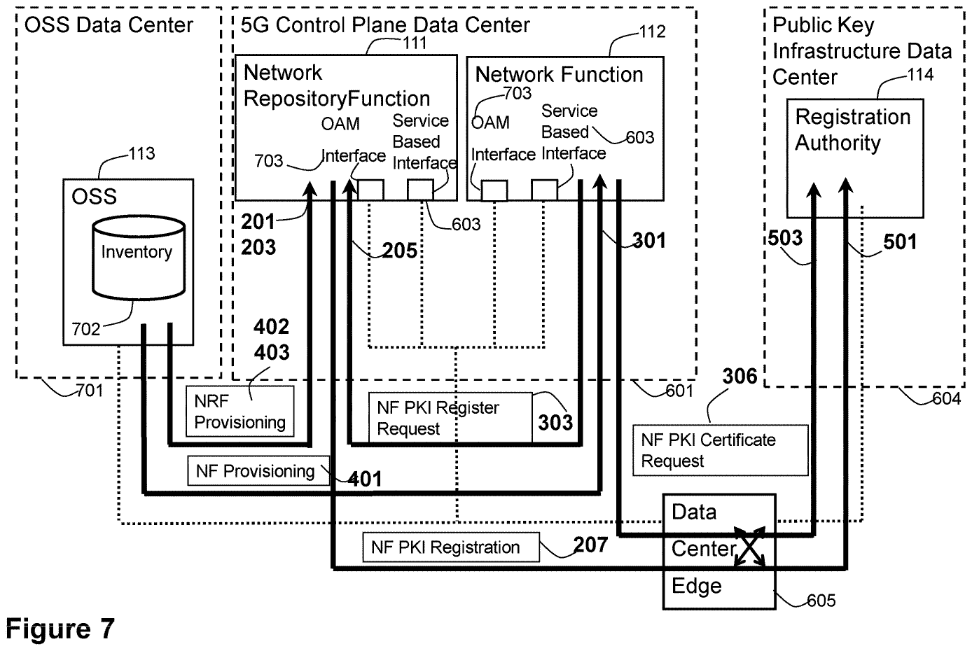

FIG. 7 is another schematic diagram depicting another non-limiting example of a detailed architecture the communications system 100 may have according to embodiments herein. FIG. 7 particularly illustrates the entities that may participate as well as some of the flows that may be part of embodiments herein. From the OSS Data Center 701, which may comprise the third node 113 as the Orchestrator System (OSS) of the Telecommunication Operator that may share the same data center as the 5G Control Plane Data Center 601 or be hosted in a specific data center 701, as depicted in FIG. 7. The third node 113 may comprise an inventory 702. The third node 113 may, according to Actions 402 and 201, provision the first node 111, an NRF in this example, with information about expected Network Functions that may appear in the communications system 100, using the first indication, e.g., a network function instance identifier with the format described in clause 5.3.2 of TS 29.571 v. 17.6.0, to univocally identify the network function, the third indication, e.g., the network function type, and the second indication, e.g., a key, to avoid NF impersonating in the environment. In addition, the third node 113 may, according to Actions 403 and 203, provision in the first node 111 the fourth indication as data about which fourth node 114, that is, which Registration Authority, to connect to, and the needed credentials to consider the first node 111 an authenticated and trusted entity. The provisioning of the first node 111 may add any other information that may be needed to carry out the different activities performed by the first node 111. The third node 113 may, according to Actions 401 and 301, provision in the second node 112 a key, the same that may have been provisioned previously in the first node 111 for that second node 112. As stated earlier, this step may be performed through the flow depicted in FIG. 7, by the third node 113, or by any other mechanism during the bootstrapping of the second node 112, such as a secure configuration file or a variable environment. When the second node 112, or another network function, connects to the first node 111 with capability to automatically request certificates for its service-based interface, the second node 112 may, according to Actions 303 and 205, perform a new request before the standardized Nnrf_NFMangementService operation NFRegister. This new request may be referred to herein as “NF PKI Register Request”. The first node 111 may then, according to Actions 207 and 501, register the second node 112 into the fourth node 114, that is, the PKI Registration Authority, to later accept certificates signing requests from this network function, according to Actions 503 and 306. As depicted in FIG. 7, each of the first node 111 and the second node 112 may comprise a respective service based interface 603 as well as a respective OAM interface 703.

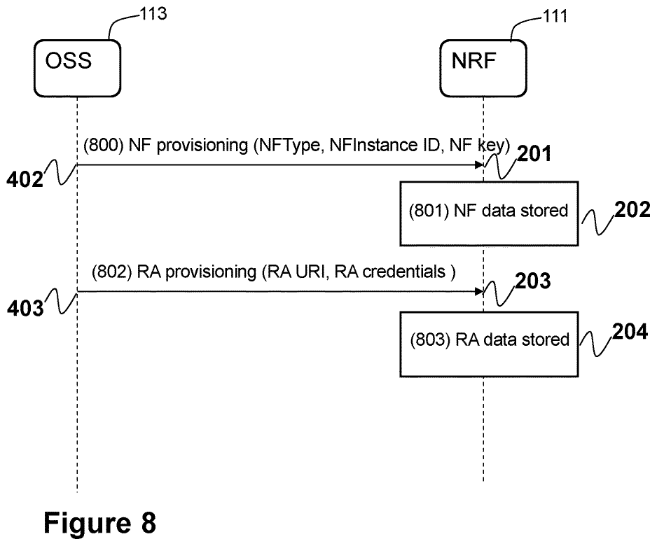

FIG. 8 and FIG. 9 depict different aspects of the provisioning of the first node 111.

FIG. 8 is a signalling diagram depicting a non-limiting example of methods performed in the communications system 100, according to embodiments herein. FIG. 8 assumes a scenario wherein the first node 111 has just been instantiated in the network operator as the first node 111 for the control plane, and no other control plane 5G node has been instantiated. The FIG. 8 illustrates a first signaling flow to illustrate the provisioning of the first node 111 by the third node 113, the operator OSS, to provide the data about expected network functions in the network and the data of the fourth node 114, that is, the registration authority. The Telecommunication Operator may use the third node 113 to orchestrate the deployment and configuration of the first node 111. The third node 113 may, according to Action 402, start provisioning the first node 111 at (800) with the information, that is, data of the Network Functions that may be deployed later in the network. The main data that may needed may be the third indication, e.g., the network function type according for example to clause 6.1.6.3.3 of TS 29.510 v. 17.4.0, “AUSF”, “UDM”, “UDR”, . . . , the first indication, e.g., the network function instance identifier with, for example, the format described in clause 5.3.2 of TS 29.571 v. 17.6.0, that may univocally identify the second node 112 and the second indication, e.g., an NF key, that may be used by the first node 111 to avoid the registration of malicious NFs that by any mechanism may guess the NF instance id. This may be understood to introduce a more secure bootstrapping of the NFs. The first node 111 may obtain the information according to Action 201. Then, the first node 111, according to Action 202, may store in its database this data at (801), to be used when the second node 112 may be instantiated and registered into the first node 111. Notice that steps 800 and 801 may be repeated for each network function that may be expected in the network. The third node 113 may, according to Action 403, provision the first node 111 at (802) with the fourth indication, that is, data about the fourth node 114, the PKI Registration Authority, that may authenticate the entities requesting certificates in this network. The first node 111 may receive the fourth indication according to Action 203 and, according to Action 204, store at (803) the data that may be used for two purposes: firstly, to request its own certificates for the service base interfaces, as it is illustrated in FIG. 9 and secondly to register each network function, as depicted in FIG. 10. The fourth indication may comprise the credentials of the fourth node 114 and the identifier of the fourth node 114 as the URI. These new services provided by the first node 111 used by the third node 113 to provision the NF Instance ID and the PKI RA data, may be performed through an OAM encrypted interface.

FIG. 9 is a signalling diagram depicting another non-limiting example of methods performed in the communications system 100, according to embodiments herein. Particularly, FIG. 9 illustrates the process through which the first node 111 may obtain its certificates for its respective service-based interfaces. With the registration authority data provided by the third node 113, the first node 111 may initiate a flow (900) to register itself into the operator PKI. The data provided in this request may be at least an identifier of the first node 111, which may be the NRF instance identifier, following for example, the format described in clause 5.3.2 of TS 29.571 v. 17.6.0, and optionally, the first node 111 may provide also its FQDN to facilitate the visual and human identification in the PKI of the operator. Since the credentials from the fourth node 114, that is, the RA credentials, have been provided, the fourth node 114, that is, the registration authority, may authenticate (901) the first node 111 creating an OTP to access the RA, or any other credentials meaning that the entity may have been registered into the PKI. The next step (902) shows the result of the operation. The first node 111 may store (903) the OTP in its database to be used later. Then, the first node 111 may create (904) a private key and with its own data, e.g., subject domain name, subject alternative name, may create a certificate signing request that may be sent (905) to the fourth node 114, together with the OTP. The fourth node 114 may validate (906) that this data comes from a trusted and previously registered entity, as was shown in step 901, and may send the request (907) to the fifth node 115, that is, the certificate authority (PKI CA) of the operator, which may generate (908) the certificate and send (909) it to the first node 111. The first node 111 may then install (910) the certificate. The first node 111 may repeat the same steps, from 904 to 910, for each certificate that it may require.

FIGS. 10-14 depict different aspects of a second signaling flow to illustrate the PKI registration towards the first node 111 when a network provision may be instantiated, and the second node 112 may want to automatically enroll the certificates.

FIG. 10 is a signalling diagram depicting another non-limiting example of methods performed in the communications system 100, according to embodiments herein. Particularly, FIG. 10 depicts the provisioning of a network function. As it may be seen in FIG. 10, at 1000, the third node 113 may, according to Actions 401 and 301, provision the second node 112 with a key that will be later used when communicating with the first node 111. This communication may be performed through an OAM encrypted interface. This process may be repeated for each second node, e.g., each NF. The NF key provisioned may be understood to have to be the same as the key provisioned by the third node 113 to the first node 111 in step 800 of FIG. 8. The provisioning of the second node 112 by the third node 113 may include some other parameters/values, e.g., the first indication, for example, the NF instance ID, the IP addresses for the interfaces, the initial user credentials, etc. At 1001, in accordance with Action 302, the second node 112 may store the information, that is NF data, received.

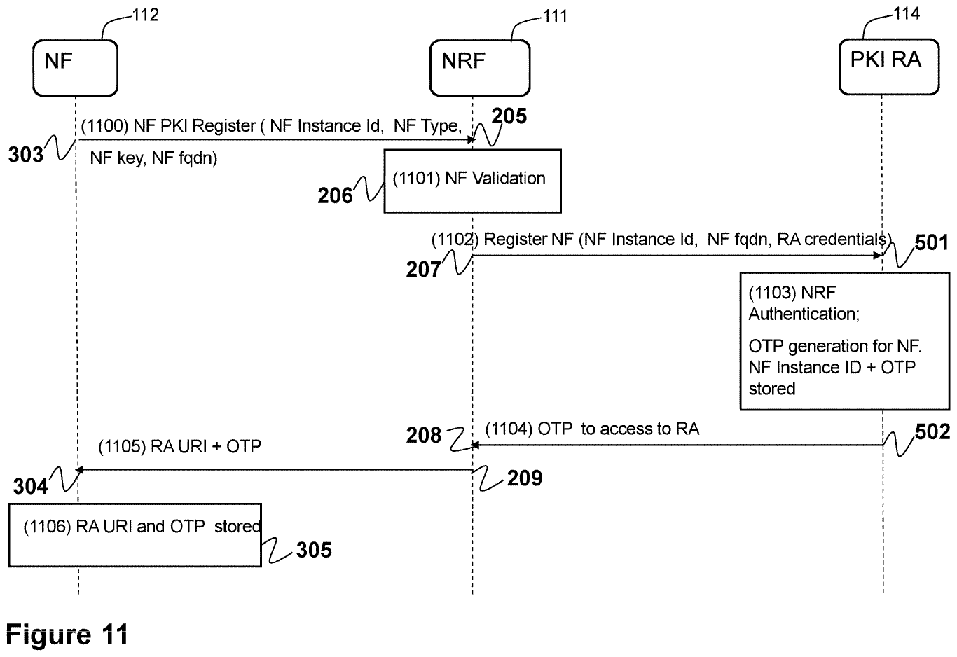

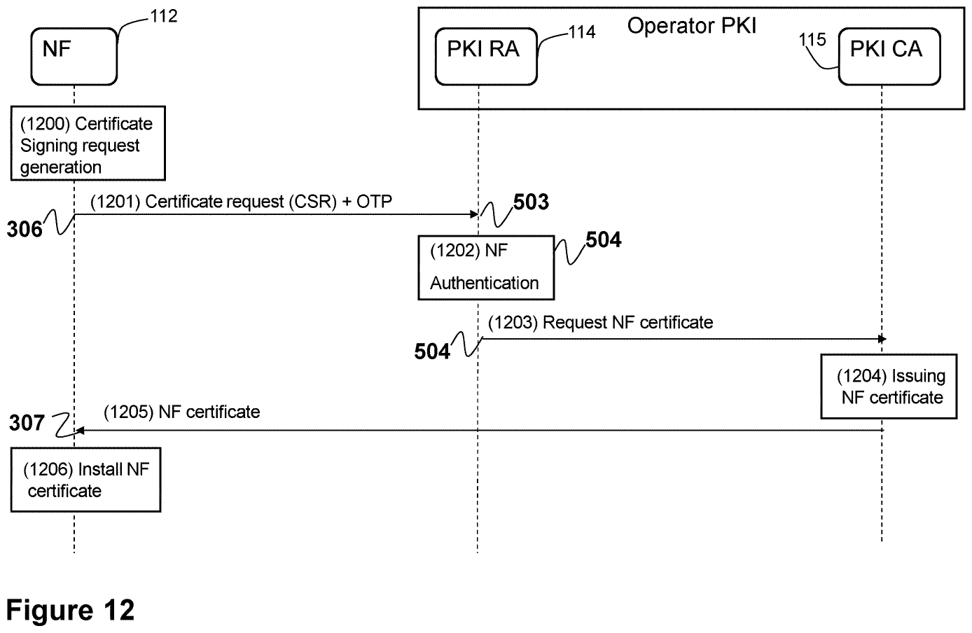

FIG. 11 is a signalling diagram depicting yet another non-limiting example of methods performed in the communications system 100, according to embodiments herein. FIG. 11 depicts the automatic registration for network functions. FIG. 11 particularly illustrates the actions that may be performed when the second node 112, a network function, may have the capability and may be configured to automatically enroll its certificates. When a control plane 5G network function such as the second node 112 in this example, may be instantiated in the communications system 100 and may have the capability to automatically enroll the certificates required for its service-based interface, it may, according to Actions 303 and 205, perform (1100) the service “NF PKI Register” provided by the first node 111 with the first indication as e.g., network function instance identifier with the format described in clause 5.3.2 of TS 29.571 v. 17.6.0, the third indication, e.g., NF Type, following the format defined in clause 6.1.6.3.3 of TS 29.510 v. 17.4.0, the second indication, e.g., an NF key provisioned by the OSS in step 1000 of FIG. 10, and optionally, its FQDN. This may be understood to be a new service “NF PKI Register” offered by the first node 111. This new service may be offered in a port that may be not protected with mutual TLS, since the NF clients may not yet be in possession of a client certificate. However, it may be protected with TLS with server certificate installed in the first node 111 during the configuration of the first node 111. In that case, the first indication, e.g., NF Instance ID, may not be eavesdropped, since the traffic may be understood to be encrypted. The first node 111, in accordance with Action 206, may validate (1101) that the second node 112 is a trusted one and expected by the network design, since in the provisioning time the first indication, e.g., NF Instance Identifier, may have been provisioned by the third node 113 and stored in first node 111 database. The first node 111 may, in accordance with Action 206, validate at 1101 that the same first indication, e.g., NF Instance Id, third indication, e.g., NF Type and second indication, e.g., NF Key, that may have been provisioned in the first node 111 in step 800 matches the first indication sent on step 1100. The first node 111 may then, according to Actions 207 and 501, register (1102) the second node 112 in the fourth node 114, the PKI Registration Authority of the operator, using the first indication, e.g., NF instance identifier, and optionally, the NF FQDN. This request may also include the RA credentials, that may just be known by the first node 111 and not by the rest of the NFs in the communications system 100. The fourth node 114 may store (1103) the network function data in its database and generate an OTP to authenticate the second node 112. The fourth node 114 may then, according to Action 502, answers to the first node 111 with this OTP to access the RA (1104). The first node 111 may receive the OTP according to Action 208. When the result is provided by the fourth node 114, the first node 111, according to Actions 209 and 304, answer (1105) to the second node 112 with the URI of the fourth node 114 and the OTP. The second node 112 may, according to Action 305, store (1106) the URI of the fourth node 114 for enrollment of the certificates together with the OTP to access to the fourth node 114, as it can be seen in FIG. 12.

FIG. 12 is a signalling diagram depicting a further non-limiting example of methods performed in the communications system 100, according to embodiments herein. FIG. 7 illustrates the process that may be used by the second node 112 to get certificates for its service-based interface, client and server certificates. Firstly, the second node 112 may generate (1200) the private key and the certificate signing request including its own data, e.g., subject domain name, subject alternative name. This certificate signing request (CSR) may then, according to Action 306 and 503, be sent (1201) to the fourth node 114, using the OTP and the URI that may have been previously stored in the second node 112 as an answer of the first node 111 service “NF PKI Register”. The fourth node 114 may then, according to Action 504, validate (1202) that this data comes from a trusted and previously registered entity, since it was registered in step 1102 through the OTP value provided, that may be understood to have to match with the one stored in the fourth node 114 for that second node 112, step 1103. The fourth node 114 may then, according to Action 504, sends the request (1203) to the fifth node 115, the PKI CA of the operator, which may generate (1204) the certificate and may then send (1205) it to the second node 112. The network function may then receive the certificate according to Action 307, and then install (1206) the certificate.

The second node 112 may repeat the same steps, from 1200 to 1206, for each certificate that it may require, and for the renovation of the certificates when a certificate may be close to expiry, or when the certificate may have been revoked. The fourth node 114, in step 1202, may reject the operation if the network function trying to get the certificate has not been registered previously.

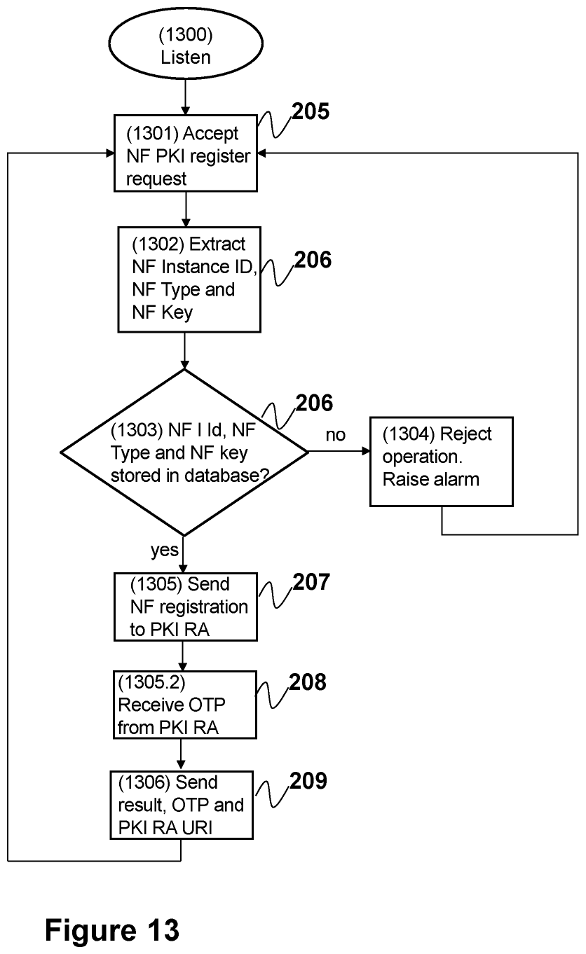

FIG. 13 is a signalling diagram depicting a non-limiting example of a method performed by the first node 111 in the communications system 100, according to embodiments herein. In FIG. 13, it is particularly depicted the process implemented by the first node 111 to provide the service “PKI NF Register”. The first node 111 may establish a new service (1300) for attending the requests performed by those network functions such as the second node 112, that may want to automatically enroll certificates for its service-based interface. For that, the first node 111 may open a server, that may listen to requests in a secure way, protected with TLS, or in an unsecure way, in clear text. This implementation may up to the first node 111 and afterwards to the operator to enable the TLS when the first node 111 may have this capability. Once the first node 111 may receive, according to Action 205, “PKI NF Register” request (1301), the first node 111 may, according to Action 206, process this request (1302) and verify (1303) that the first indication of the second node 112 is stored in the database of the first node 111, meaning that the second node 112 is a trusted and expected network function. In case the first indication, e.g., network function instance identifier plus the third indication, e.g., NF type and the second indication, e.g., NF key, are not found in the NRF database (1304), the operation may be rejected, sending the correspondent result to the second node 112 and an alarm may be raised to inform to the operator that an error has occurred. In case the received first indication, e.g., network function instance identifier, is found in the database of the first node 111, matching also the third indication, e.g., NF Type and the second indication, e.g., NF key, stored with the third indication and second indication received, the first node 111 may, according to Action 207, perform the registration (1305) of the second node 112 in the fourth node 114, the operator PKI Registration Authority, and it may, according to Action 208, receive as a result (1305.2) the OTP to be used by the second node 112. The first node 111 may then, according to Action 209, return to the second node 112 (1306) the result, that is, the OTP and the URI of the fourth node 114, which may be stored by the second node 112. The first node 111 may continue listening to new requests for other network functions.

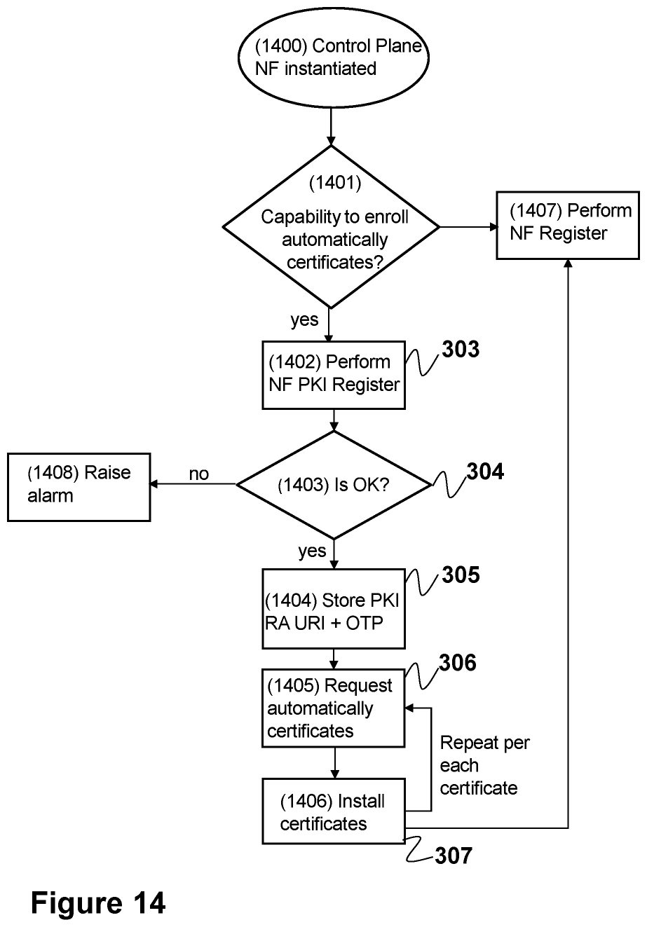

FIG. 14 is a signalling diagram depicting another non-limiting example of methods performed in the communications system 100, according to embodiments herein. Particularly, FIG. 14 illustrates the process performed by the second node 112 during its bootstrapping. When a network function such as the second node 112 in the control plane 5G architecture is instantiated (1400) and the service base interface may need to be encrypted at the configuration of the Telecommunications Operator, if the second node 112 has the capability to enroll certificates automatically (1401), then the second node 112 may perform the “PKI NF Register” operation (1402) according to Action 303. This procedure has been already explained in FIG. 12. If the answer received according to Action 304 is OK (1403), then the second node 112 may store the URI and the OTP from the fourth node 114 (1404) according to Action 305 and start requesting all the certificates needed for its operation according to Action 306. The second node 112 may receive the certificate according to Action 307 and install the certificate at 1406. Steps 1405 and 1406 may be repeated per each certificate.

In case the answer is not OK (1408) and alarm may be raised to alert the Service Provider.

After getting all the certificates, the usual bootstrapping process defined in 3GPP may continue (1407), and the second node 112 may register in the first node 111 performing the operation “NFRegister” provided by the service Nnrf_NFMangement in a secure way, using mutual TLS. It may be noted that the URI of the first node 111 may be understood to be a configuration parameter.

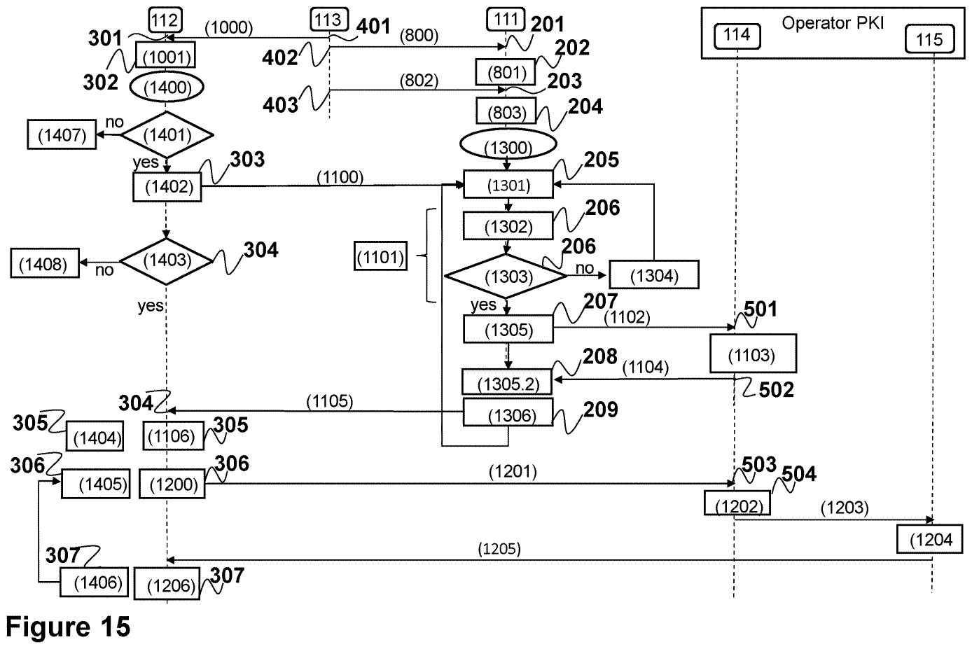

FIG. 15 is a global signalling diagram depicting a non-limiting example of methods performed in the communications system 100, summarizing the whole context of embodiments herein. To accommodate all the actions in a single Figure, the actions from the different figures already described are indicated using the same reference numbers.

As a summarized view of the foregoing, embodiments herein may be understood to relate to a new method on a NF to accept provisioning data from an OSS with a proper key to avoid impersonation attacks in the core network, see for example step 1000 of FIG. 10.

Embodiments herein may also relate to a new method on the NRF to accept provisioning data from an OSS to know which network functions may be expected in the network and if they may be considered trusted, see for example step 800 of FIG. 8 and step 801. Embodiments herein may further relate to a new method on the NRF to accept provisioning data form an OSS to know the data of the PKI RA, see for example step 802 of FIG. 8 and step 803.

Embodiments herein may further relate to a new method on the NRF to register the network functions that may be trusted and expected in this environment, after the previous provisioning described in step 800 of FIG. 8 in the operator PKI RA, step 1301 of FIG. 13 and the whole process described in FIG. 13. Embodiments herein may also relate to a new method performed for each network function through the NRF to register into the operator PKI to get the certificates before doing the 3GPP register in the network, see for example step 1402 in FIG. 14 and steps 1403 and 1404.

Certain embodiments disclosed herein may provide one or more of the following technical advantage(s), which may be summarized as follows.

As a first advantage, embodiments herein may be understood to enable an automatic registration of each network function such as the second node 112, towards a Registration Authority in a PKI infrastructure such as the fourth node 114 as a previous step for the fifth node 115, that is, a Certificate Authority, to issue certificates, in a trusted way.

This may in turn enable the operator deploying 5G core architecture to add a new step to the path of a fully automatic and trusted environment, avoiding manual intervention except for the provisioning of the network functions in the first node 111, e.g., the NRF, that may be performed for different purposes. According to embodiments herein, the provisioning of the network function in the first node 111 may allow to check if the second node 112 to be registered is known by the operator, avoiding the instantiation and registration in the network of malicious NFs.

The first node 111, e.g., the NRF, may therefore be enabled to increase its role as Network Function security anchor, acting as a proxy towards the fourth node 114, a registration authority in the network operator.

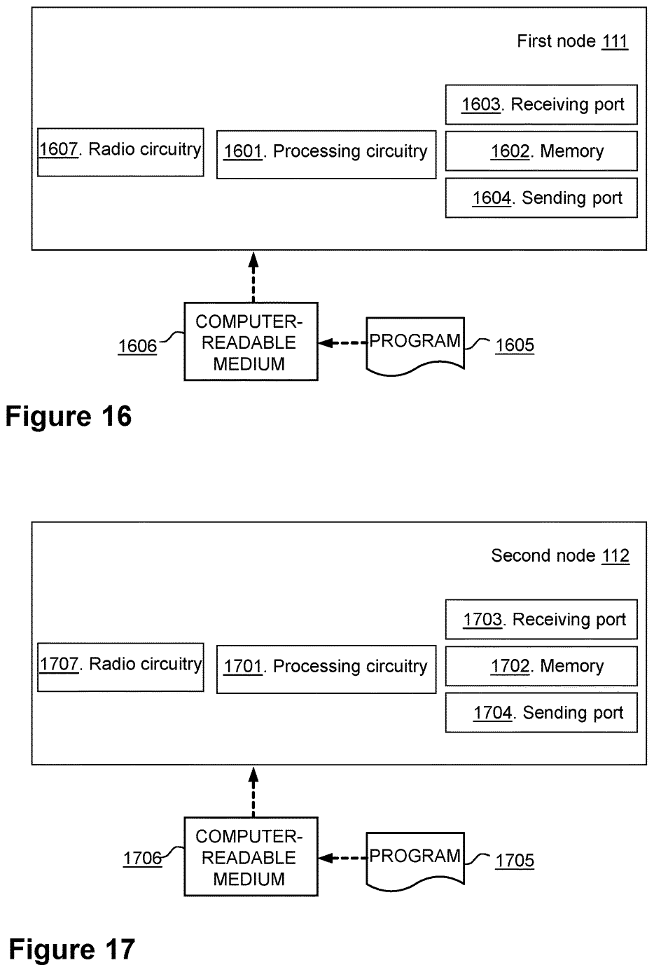

FIG. 16 depicts an example of the arrangement that the first node 111 may comprise to perform the method described in FIG. 2, FIGS. 7-9, FIG. 11, FIG. 13 and/or FIG. 15. The first node 11 may be understood to be for handling the registration of the network second node 112. The first node 111 may be configured to operate in the communications system 100.

Several embodiments are comprised herein. It should be noted that the examples herein are not mutually exclusive. One or more embodiments may be combined, where applicable. All possible combinations are not described to simplify the description.

Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first node 111 and will thus not be repeated here. For example, the type of the second node 112 may be a network function type, for example, according to clause 6.1.6.3.3 of TS 29.510 v. 17.4.0, Authentication Server Function (AUSF), Unified Data Management (UDM), Unified Data Repository (UDR), etc.

The first node 111 is configured to obtain the information configured to enable to identify the second node 112. The second node 112 is configured to be expected to operate in the communications system 100. The obtaining of the information is configured to be from the third node 113 configured to be operating in the communications system 100.

The first node 111 is also configured to receive, after having obtained the information, the first request from the second node 112. The first request is configured to indicate the information.

The first node 111 may be also configured to determine, responsive to the first request configured to be received and based on the information configured to be obtained and the information of the first request, whether or not the second node 112 is a node which is expected to operate in the communication system 100.

In some embodiments, the first node 111 may be further configured to send, based on the result of the determination, the second request to the fourth node 114. The fourth node 113 is configured to operate for the communications system 100 as the PKI RA. The second request is configured to be to register the second node 112, so that a later request for processing of a certificate from the second node 112 is accepted.

In some embodiments, that the sending of the second request is configured to be based on a result of the determination, may be configured to comprise one of: a) sending the second request with the proviso the result of the determination is positive, and b) refraining from sending the second request and sending an alarm with the proviso the result of the determination is negative.

In some embodiments, the information may be configured to comprise the first indication configured to identify the second node 112.

In some embodiments, the information may be configured to comprise the second indication configured to indicate the key assigned to the second node 112.

In some embodiments, the information may be further configured to comprise the third indication configured to indicate the type of the second node 112.

In some embodiments, the first node 111 may be further configured to store the information configured to be obtained in the memory of the first node 111.

In some embodiments, the first node 111 may be also configured to receive, responsive to the second request configured to be sent, the first response from the fourth node 114. The first response is configured to indicate the registration of the second node 112 at the fourth node 114.

In some embodiments, the first node 111 may be further configured to send, responsive to the first response configured to be received, the second response to the second node 112. The second response may be configured to indicate the registration of the second node 112 at the fourth node 114.

In some embodiments, the first node 111 may be further configured to obtain, prior to the sending of the second request, the fourth indication from the third node 113. The fourth indication may be configured to indicate the fourth node 114.

In some embodiments, the first node 111 may be also configured to store the fourth indication configured to be obtained in the memory of the first node 111.

In some embodiments, at least one of the following may apply: a) the second node 112 may be configured to have the capability to automatically request certificates for the service-based interface of the second node 112, b) the communications system 100 may be configured to be a 5G, system, c) the first node 111 may be configured to be an NRF node, d) the second node 112 may be configured to be an NF, e) the third node 113 may be configured to be an OSS node, f) the fourth node 114 may be configured to be an RA node, g) the first request may be configured to be an NF PKI Register Request, h) the request for processing of the certificate may be configured to be a CSR, i) the obtaining of the information may be configured to be via an encrypted interface, j) the second request may be configured to comprise the information, k) the second response may be configured to comprise the OTP, configured to be issued by the fourth node 114 and the identifier of the fourth node 114, l) the fourth indication may be configured to comprise the credentials of the fourth node 114 and the identifier of the fourth node 114, and m) the identifier of the fourth node 114 may be configured to be the URI of the fourth node 114.

The embodiments herein in the first node 111 may be implemented through one or more processors, such as a processing circuitry 1601 in the first node 111 depicted in FIG. 16, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first node 111. One such carrier may be in the form of a CD ROM disc. It is however feasible with other data carriers such as a memory stick. The computer program code may furthermore be provided as pure program code on a server and downloaded to the first node 111.

The first node 111 may further comprise a memory 1602 comprising one or more memory units. The memory 1602 is arranged to be used to store obtained information, store data, configurations, schedulings, and applications etc. to perform the methods herein when being executed in the first node 111.

In some embodiments, the first node 111 may receive information from, e.g., the second node 112, the third node 113, the fourth node 114, the fifth node 115, and/or another structure in the computer system 100, through a receiving port 1603. In some embodiments, the receiving port 1603 may be, for example, connected to one or more antennas in first node 111. In other embodiments, the first node 111 may receive information from another structure in the computer system 100 through the receiving port 1603. Since the receiving port 1603 may be in communication with the processing circuitry 1601, the receiving port 1603 may then send the received information to the processing circuitry 1601. The receiving port 1603 may also be configured to receive other information.

The processing circuitry 1601 in the first node 111 may be further configured to transmit or send information to e.g., any of the second node 112, the third node 113, the fourth node 114, the fifth node 115 and/or another structure in the computer system 100, through a sending port 1604, which may be in communication with the processing circuitry 1601, and the memory 1602.

Those skilled in the art will also appreciate that the units comprised within the first node 111 described above as being configured to perform different actions, may refer to a combination of analog and digital circuits, and/or one or more processors configured with software and/or firmware, e.g., stored in memory, that, when executed by the one or more processors such as the processing circuitry 1601, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units comprised within the first node 111 described above as being configured to perform different actions described above may be implemented as one or more applications running on one or more processors such as the processing circuitry 1601.

Thus, the methods according to the embodiments described herein for the first node 111 may be respectively implemented by means of a computer program 1605 product, comprising instructions, i.e., software code portions, which, when executed on at least one processing circuitry 1601, cause the at least one processing circuitry 1601 to carry out the actions described herein, as performed by the first node 111. The computer program 1605 product may be stored on a computer-readable storage medium 1606. The computer-readable storage medium 1606, having stored thereon the computer program 1605, may comprise instructions which, when executed on at least one processing circuitry 1601, cause the at least one processing circuitry 1601 to carry out the actions described herein, as performed by the first node 111. In some embodiments, the computer-readable storage medium 1606 may be a non-transitory computer-readable storage medium, such as a CD ROM disc, or a memory stick. In other embodiments, the computer program 1605 product may be stored on a carrier containing the computer program 1605 just described, wherein the carrier is one of an electronic signal, optical signal, radio signal, or the computer-readable storage medium 1606, as described above.

The first node 111 may comprise a communication interface configured to facilitate, or an interface unit to facilitate, communications between the first node 111 and other nodes or devices, e.g., the second node 112, the third node 113, the fourth node 114, the fifth node 115 and/or another structure in the computer system 100. The interface may, for example, include a transceiver configured to transmit and receive radio signals over an air interface in accordance with a suitable standard.

In other embodiments, the first node 111 may comprise a radio circuitry 1607, which may comprise e.g., the receiving port 1603 and the sending port 1604.

The radio circuitry 1607 may be configured to set up and maintain at least a wireless connection with the any of the second node 112, the third node 113, the fourth node 114, the fifth node 115 and/or another structure in the computer system 100. Circuitry may be understood herein as a hardware component.

Hence, embodiments herein also relate to the first node 111 operative to operate in the computer system 100. The first node 111 may comprise the processing circuitry 1601 and the memory 1602, said memory 1602 containing instructions executable by said processing circuitry 1601, whereby the first node 111 is further operative to perform the actions described herein in relation to the first node 111, e.g., in FIG. 2, FIGS. 7-9, FIG. 11, FIG. 13 and/or FIG. 15.

FIG. 17 depicts an example of the arrangement that the second node 112 may comprise to perform the method described in FIG. 3, FIG. 7, FIGS. 10-12 and/or FIGS. 14-15. The second node 112 may be configured to be expected to operate in the communications system 100. The second node 112 may be understood to be for handling registration of the second node 112.

Several embodiments are comprised herein. It should be noted that the examples herein are not mutually exclusive. One or more embodiments may be combined, where applicable. All possible combinations are not described to simplify the description.

Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the second node 112 and will thus not be repeated here. For example, the type of the second node 112 may be a network function type, for example, according to clause 6.1.6.3.3 of TS 29.510 v. 17.4.0, Authentication Server Function (AUSF), Unified Data Management (UDM), Unified Data Repository (UDR), etc.

The second node 112 is configured to obtain the information configured to enable to identify the second node 112 in the communications system 100.

The second node 112 is also configured to send, after having obtained the information, the first request to the first node 111 configured to operate in the communications system 100. The first request is configured to indicate the information.

In some embodiments, the second node 112 is further configured to receive, responsive to the first request configured to be sent and based on the information configured to be obtained, the second response from the first node 111. The second response is configured to indicate the registration of the second node 112 at the fourth node 114 configured to operate for the communications system 100, so that a later request for processing of a certificate from the second node 112 is accepted.

In some embodiments, the information may be configured to comprise the first indication configured to identify the second node 112.

In some embodiments, the information may be configured to comprise the second indication configured to indicate the key assigned to the second node 112.

In some embodiments, the information may be further configured to comprise the third indication configured to indicate the type of the second node 112.

In some embodiments, the second node 112 may be further configured to store the information configured to be obtained in the memory of the second node 112.

In some embodiments wherein the second response may be configured to comprise the OTP configured to be issued by the fourth node 114, and the identifier of the fourth node 114, the second node 112 may be further configured to store the OTP and identifier of the fourth node 114 configured to be obtained in the memory of the second node 112.

In some embodiments wherein the second response may be configured to comprise the OTP configured to be issued by the fourth node 114, and the identifier of the fourth node 114, the second node 112 may be further configured to send, along with the OTP, the third request to the fourth node 114. The third request may be configured to request processing of the certificate.

In some embodiments wherein the second response may be configured to comprise the OTP configured to be issued by the fourth node 114, and the identifier of the fourth node 114, the second node 112 may be further configured to receive, responsive to the sent third request, the third response from the fifth node 115 configured to operate for the communications system 100. The third response may be configured to comprise the certificate configured to be requested.

In some embodiments, at least one of the following may apply: a) the second node 112 may be configured to have the capability to automatically request certificates for the service-based interface of the second node 112, b) the communications system 100 may be configured to be a 5G, system, c) the first node 111 may be configured to be an NRF node, d) the second node 112 may be configured to be an NF, e) the obtaining of the information may be configured to be from the third node 113 configured to operate in the communications system 100, f) the third node 113 may be configured to be an OSS node, g) the fourth node 114 may be configured to be an RA node, h) the first request may be configured to be an NF PKI Register Request, i) the request for processing of the certificate may be configured to be a CSR, j) the obtaining of the information may be configured to be via an encrypted interface, k) the second request may be configured to comprise the identifier of the fourth node 114. The identifier of the fourth node 114 may be configured to be the URI of the fourth node 114.

The embodiments herein in the second node 112 may be implemented through one or more processors, such as a processing circuitry 1701 in the second node 112 depicted in FIG. 11, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the second node 112. One such carrier may be in the form of a CD ROM disc. It is however feasible with other data carriers such as a memory stick. The computer program code may furthermore be provided as pure program code on a server and downloaded to the second node 112.

The second node 112 may further comprise a memory 1702 comprising one or more memory units. The memory 1702 is arranged to be used to store obtained information, store data, configurations, schedulings, and applications etc. to perform the methods herein when being executed in the second node 112.

In some embodiments, the second node 112 may receive information from, e.g., any of the first node 111, the third node 113, the fourth node 114, the fifth node 115 and/or another structure in the computer system 100, through a receiving port 1703. In some embodiments, the receiving port 1703 may be, for example, connected to one or more antennas in second node 112. In other embodiments, the second node 112 may receive information from another structure in the computer system 100 through the receiving port 1703. Since the receiving port 1703 may be in communication with the processing circuitry 1701, the receiving port 1703 may then send the received information to the processing circuitry 1701. The receiving port 1703 may also be configured to receive other information.

The processing circuitry 1701 in the second node 112 may be further configured to transmit or send information to e.g., any of the first node 111, the third node 113, the fourth node 114, the fifth node 115 and/or another structure in the computer system 100, through a sending port 1704, which may be in communication with the processing circuitry 1701, and the memory 1702.

Those skilled in the art will also appreciate that the units comprised within the second node 112 described above as being configured to perform different actions, may refer to a combination of analog and digital circuits, and/or one or more processors configured with software and/or firmware, e.g., stored in memory, that, when executed by the one or more processors such as the processing circuitry 1701, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units comprised within the second node 112 described above as being configured to perform different actions described above may be implemented as one or more applications running on one or more processors such as the processing circuitry 1701.

Thus, the methods according to the embodiments described herein for the second node 112 may be respectively implemented by means of a computer program 1705 product, comprising instructions, i.e., software code portions, which, when executed on at least one processing circuitry 1701, cause the at least one processing circuitry 1701 to carry out the actions described herein, as performed by the second node 112. The computer program 1705 product may be stored on a computer-readable storage medium 1706. The computer-readable storage medium 1706, having stored thereon the computer program 1705, may comprise instructions which, when executed on at least one processing circuitry 1701, cause the at least one processing circuitry 1701 to carry out the actions described herein, as performed by the second node 112. In some embodiments, the computer-readable storage medium 1706 may be a non-transitory computer-readable storage medium, such as a CD ROM disc, or a memory stick. In other embodiments, the computer program 1705 product may be stored on a carrier containing the computer program 1705 just described, wherein the carrier is one of an electronic signal, optical signal, radio signal, or the computer-readable storage medium 1706, as described above.

The second node 112 may comprise a communication interface configured to facilitate, or an interface unit to facilitate, communications between the second node 112 and other nodes or devices, e.g., any of the first node 111, the third node 113, the fourth node 114, the fifth node 115 and/or another structure in the computer system 100. The interface may, for example, include a transceiver configured to transmit and receive radio signals over an air interface in accordance with a suitable standard.

In other embodiments, the second node 112 may comprise a radio circuitry 1707, which may comprise e.g., the receiving port 1703 and the sending port 1704.

The radio circuitry 1707 may be configured to set up and maintain at least a wireless connection with the any of the first node 111, the third node 113, the fourth node 114, the fifth node 115 and/or another structure in the computer system 100. Circuitry may be understood herein as a hardware component.

Hence, embodiments herein also relate to the second node 112 operative to operate in the computer system 100. The second node 112 may comprise the processing circuitry 1701 and the memory 1702, said memory 1702 containing instructions executable by said processing circuitry 1701, whereby the second node 112 is further operative to perform the actions described herein in relation to the second node 112, e.g., in FIG. 3, FIG. 7, FIGS. 10-12 and/or FIGS. 14-15.

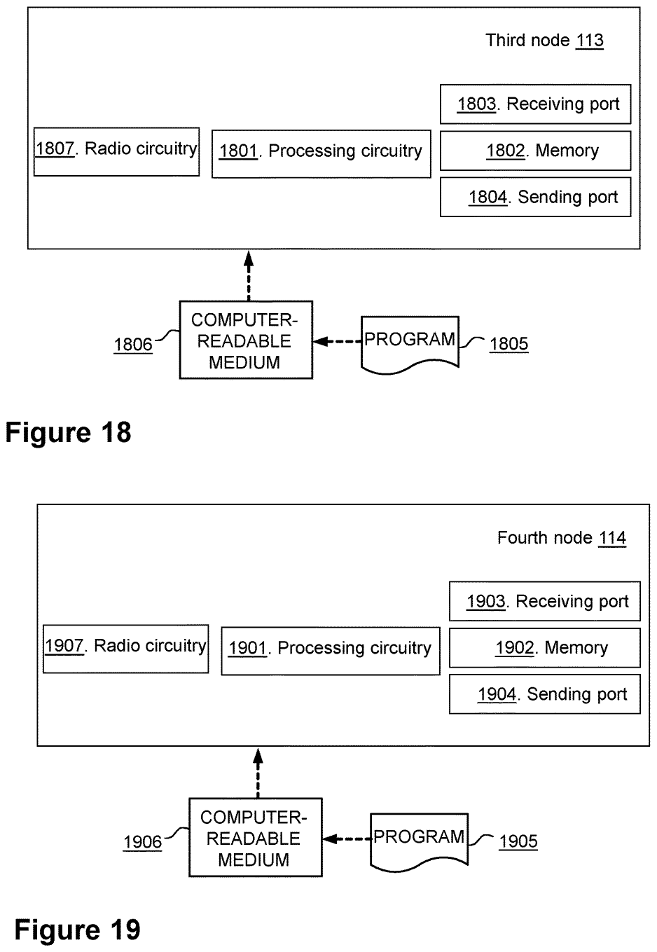

FIG. 18 depicts an example of the arrangement that the third node 113 may comprise to perform the method described in FIG. 4, FIGS. 7-8, FIG. 10 and/or FIG. 15 in some embodiments. The third node 113 may be configured to operate in the computer system 100 or to be comprised in the computer system 100. The third node 113 may be understood to be for handling registration of the second node 112.

Several embodiments are comprised herein. It should be noted that the examples herein are not mutually exclusive. One or more embodiments may be combined, where applicable. All possible combinations are not described to simplify the description.

Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the third node 113 and will thus not be repeated here. For example, the type of the second node 112 may be a network function type, for example, according to clause 6.1.6.3.3 of TS 29.510 v. 17.4.0, Authentication Server Function (AUSF), Unified Data Management (UDM), Unified Data Repository (UDR), etc.

The third node 113 is configured to provide the information configured to enable to identify the second node 112 configured to be expected to operate in the communications system 100. The providing of the information is to the first node 111 configured to operate in the communications system 100.

The third node 113 is also configured to provide, to the first node 111, the fourth indication configured to indicate the fourth node 114 configured to operate for the communications system 100 as the PKI RA, thereby being configured to enable the first node 111 to, with the information and the fourth indication, request the fourth node 114 to register the second node 112, so that a later request for processing of a certificate from the second node 112 is accepted.

In some embodiments, the information may be configured to comprise the first indication configured to identify the second node 112.

In some embodiments, the information may be configured to comprise the second indication configured to indicate the key assigned to the second node 112.

In some embodiments, the information may be further configured to comprise the third indication configured to indicate the type of the second node 112.

The third node 113 may be further configured to provide the information configured to enable to identify the second node 112, to the second node 112.

In some embodiments, at least one of the following may apply: a) the second node 112 may be configured to have the capability to automatically request certificates for the service-based interface of the second node 112, b) the communications system 100 may be configured to be a 5G, system, c) the first node 111 may be configured to be an NRF node, d) the second node 112 may be configured to be an NF, e) the third node 113 may be configured to be an OSS node, f) the fourth node 114 may be configured to be an RA node, g) the providing of the information to the first node 111 may be further configured to comprise providing the same information to the second node, h) the request for processing of the certificate may be configured to be a CSR, i) the providing of the information may be via an encrypted interface, and j) the fourth indication may be configured to comprise the credentials of the fourth node 114 and the URI of the fourth node 114.

The embodiments herein in the third node 113 may be implemented through one or more processors, such as a processing circuitry 1801 in the third node 113 depicted in FIG. 18, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the third node 113. One such carrier may be in the form of a CD ROM disc. It is however feasible with other data carriers such as a memory stick. The computer program code may furthermore be provided as pure program code on a server and downloaded to the third node 113.

The third node 113 may further comprise a memory 1802 comprising one or more memory units. The memory 1802 is arranged to be used to store obtained information, store data, configurations, schedulings, and applications etc. to perform the methods herein when being executed in the third node 113.

In some embodiments, the third node 113 may receive information from, e.g., any of the first node 111, the second node 112, the fourth node 114, the fifth node 115 and/or another structure in the computer system 100, through a receiving port 1803. In some embodiments, the receiving port 1803 may be, for example, connected to one or more antennas in third node 113. In other embodiments, the third node 113 may receive information from another structure in the computer system 100 through the receiving port 1803. Since the receiving port 1803 may be in communication with the processing circuitry 1801, the receiving port 1803 may then send the received information to the processing circuitry 1801. The receiving port 1803 may also be configured to receive other information.

The processing circuitry 1801 in the third node 113 may be further configured to transmit or send information to e.g., any of the first node 111, the second node 112, the fourth node 114, the fifth node 115 and/or another structure in the computer system 100, through a sending port 1804, which may be in communication with the processing circuitry 1801, and the memory 1802.

Those skilled in the art will also appreciate that the units comprised within the third node 113 described above as being configured to perform different actions, may refer to a combination of analog and digital circuits, and/or one or more processors configured with software and/or firmware, e.g., stored in memory, that, when executed by the one or more processors such as the processing circuitry 1801, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units comprised within the third node 113 described above as being configured to perform different actions described above may be implemented as one or more applications running on one or more processors such as the processing circuitry 1801.

Thus, the methods according to the embodiments described herein for the third node 113 may be respectively implemented by means of a computer program 1805 product, comprising instructions, i.e., software code portions, which, when executed on at least one processing circuitry 1801, cause the at least one processing circuitry 1801 to carry out the actions described herein, as performed by the third node 113. The computer program 1805 product may be stored on a computer-readable storage medium 1806. The computer-readable storage medium 1806, having stored thereon the computer program 1805, may comprise instructions which, when executed on at least one processing circuitry 1801, cause the at least one processing circuitry 1801 to carry out the actions described herein, as performed by the third node 113. In some embodiments, the computer-readable storage medium 1806 may be a non-transitory computer-readable storage medium, such as a CD ROM disc, or a memory stick. In other embodiments, the computer program 1805 product may be stored on a carrier containing the computer program 1805 just described, wherein the carrier is one of an electronic signal, optical signal, radio signal, or the computer-readable storage medium 1806, as described above.

The third node 113 may comprise a communication interface configured to facilitate, or an interface unit to facilitate, communications between the third node 113 and other nodes or devices, e.g., any of the first node 111, the second node 112, the fourth node 114, the fifth node 115 and/or another structure in the computer system 100. The interface may, for example, include a transceiver configured to transmit and receive radio signals over an air interface in accordance with a suitable standard.

In other embodiments, the third node 113 may comprise a radio circuitry 1807, which may comprise e.g., the receiving port 1803 and the sending port 1804.

The radio circuitry 1807 may be configured to set up and maintain at least a wireless connection with the any of the first node 111, the second node 112, the fourth node 114, the fifth node 115 and/or another structure in the computer system 100. Circuitry may be understood herein as a hardware component.

Hence, embodiments herein also relate to the third node 113 operative to operate in the computer system 100. The third node 113 may comprise the processing circuitry 1801 and the memory 1802, said memory 1802 containing instructions executable by said processing circuitry 1801, whereby the third node 113 is further operative to perform the actions described herein in relation to the third node 113, e.g., in FIG. 4, FIGS. 7-8, FIG. 10 and/or FIG. 15.

FIG. 19 depicts an example of the arrangement that the fourth node 114 may comprise to perform the method described in FIG. 5, FIG. 7, FIG. 9, FIGS. 11-12, and/or FIG. 15 in some embodiments. The fourth node 114 may be configured to operate for the computer system 100 as a PKI RA. The fourth node 114 may be understood to be for handling registration of the second node 112. The second node 112 is configured to be expected to operate in the communications system 100.

Several embodiments are comprised herein. It should be noted that the examples herein are not mutually exclusive. One or more embodiments may be combined, where applicable. All possible combinations are not described to simplify the description.

Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the sixth node 116 and will thus not be repeated here. For example, the type of the second node 112 may be a network function type, for example, according to clause 6.1.6.3.3 of TS 29.510 v. 17.4.0, Authentication Server Function (AUSF), Unified Data Management (UDM), The fourth node 114 is configured to receive the second request from the first node 111 configured to operate in the communications system 100. The second request is configured to be to register the second node 112, so that later requests for processing of a certificate from the second node 112 are accepted. The second request is configured to comprise the information configured to enable to identify the second node 112 in the communications system 100.

The fourth node 114 is also configured to send, responsive to the received second request, the first response to the first node 111. The first response is configured to indicate the registration of the second node 112 at the fourth node 114.

In some embodiments, the information may be configured to comprise the first indication configured to identify the second node 112.

In some embodiments, the information may be configured to comprise the second indication configured to indicate the key assigned to the second node 112.

In some embodiments, the information may be further configured to comprise the third indication configured to indicate the type of the second node 112.

In some embodiments, wherein the first response may be configured to comprise the OTP configured to be issued by the fourth node 114, and the identifier of the fourth node 114, the fourth node 114 may be further configured to initiate, responsive to the received third request, the third response from the fifth node 115. The fifth node 115 may be configured to operate for the communications system 100 to the second node 112. The third response may be configured to comprise the certificate configured to be requested.

In some embodiments, wherein the first response may be configured to comprise the OTP configured to be issued by the fourth node 114, and the identifier of the fourth node 114, the fourth node 114 may be further configured to

In some embodiments, at least one of the following may apply: a) the second node 112 may be configured to have the capability to automatically request certificates for the service-based interface of the second node 112, b) the communications system 100 may be configured to be a 5G, system, c) the first node 111 may be configured to be an NRF node, d) the second node 112 may be configured to be an NF, e) the fourth node 114 may be configured to be an RA node, f) the request for processing of the certificate may be configured to be a CSR, g) the first response may be configured to comprise the identifier of the fourth node 114. The identifier of the fourth node 114 may be configured to be the URI of the fourth node 114.

The embodiments herein in the third node 113 may be implemented through one or more processors, such as a processing circuitry 1901 in the third node 113 depicted in FIG. 12, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the third node 113. One such carrier may be in the form of a CD ROM disc. It is however feasible with other data carriers such as a memory stick. The computer program code may furthermore be provided as pure program code on a server and downloaded to the third node 113.

The third node 113 may further comprise a memory 1902 comprising one or more memory units. The memory 1902 is arranged to be used to store obtained information, store data, configurations, schedulings, and applications etc. to perform the methods herein when being executed in the third node 113.

In some embodiments, the third node 113 may receive information from, e.g., any of the first node 111, the second node 112, the fourth node 114, the fifth node, the another node and/or another structure in the computer system 100, through a receiving port 1903. In some embodiments, the receiving port 1903 may be, for example, connected to one or more antennas in third node 113. In other embodiments, the third node 113 may receive information from another structure in the computer system 100 through the receiving port 1903. Since the receiving port 1903 may be in communication with the processing circuitry 1901, the receiving port 1903 may then send the received information to the processing circuitry 1901. The receiving port 1903 may also be configured to receive other information.

The processing circuitry 1901 in the third node 113 may be further configured to transmit or send information to e.g., any of the first node 111, the second node 112, the fourth node 114, the fifth node, the another node and/or another structure in the computer system 100, through a sending port 1904, which may be in communication with the processing circuitry 1901, and the memory 1902.

Those skilled in the art will also appreciate that the units comprised within the third node 113 described above as being configured to perform different actions, may refer to a combination of analog and digital circuits, and/or one or more processors configured with software and/or firmware, e.g., stored in memory, that, when executed by the one or more processors such as the processing circuitry 1901, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units comprised within the third node 113 described above as being configured to perform different actions described above may be implemented as one or more applications running on one or more processors such as the processing circuitry 1901.

Thus, the methods according to the embodiments described herein for the third node 113 may be respectively implemented by means of a computer program 1905 product, comprising instructions, i.e., software code portions, which, when executed on at least one processing circuitry 1901, cause the at least one processing circuitry 1901 to carry out the actions described herein, as performed by the third node 113. The computer program 1905 product may be stored on a computer-readable storage medium 1906. The computer-readable storage medium 1906, having stored thereon the computer program 1905, may comprise instructions which, when executed on at least one processing circuitry 1901, cause the at least one processing circuitry 1901 to carry out the actions described herein, as performed by the third node 113. In some embodiments, the computer-readable storage medium 1906 may be a non-transitory computer-readable storage medium, such as a CD ROM disc, or a memory stick. In other embodiments, the computer program 1905 product may be stored on a carrier containing the computer program 1905 just described, wherein the carrier is one of an electronic signal, optical signal, radio signal, or the computer-readable storage medium 1906, as described above.

The third node 113 may comprise a communication interface configured to facilitate, or an interface unit to facilitate, communications between the third node 113 and other nodes or devices, e.g., any of the first node 111, the second node 112, the fourth node 114, the fifth node, the another node and/or another structure in the computer system 100. The interface may, for example, include a transceiver configured to transmit and receive radio signals over an air interface in accordance with a suitable standard.

In other embodiments, the third node 113 may comprise a radio circuitry 1907, which may comprise e.g., the receiving port 1903 and the sending port 1904.

The radio circuitry 1907 may be configured to set up and maintain at least a wireless connection with the any of the first node 111, the second node 112, the fourth node 114, the fifth node, the another node and/or another structure in the computer system 100. Circuitry may be understood herein as a hardware component.

Hence, embodiments herein also relate to the third node 113 operative to operate in the computer system 100. The third node 113 may comprise the processing circuitry 1901 and the memory 1902, said memory 1902 containing instructions executable by said processing circuitry 1901, whereby the third node 113 is further operative to perform the actions described herein in relation to the third node 113, e.g., in FIG. 4, and/or FIG. 8-9.

Embodiments herein may also comprise the communications system 100 comprising the first node 111 configured as described in relation to FIG. 16, a second node 112 as described in relation to FIG. 17, a third node 113 as described in relation to FIG. 18, and a fourth node 114 as described in relation to FIG. 19.

When using the word “comprise” or “comprising”, it shall be interpreted as non-limiting, i.e., meaning “consist at least of”.

The embodiments herein are not limited to the above-described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise.

The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

1.-55. (canceled)

56. A computer-implemented method performed by a first node configured to operate in a communications system, the method comprising:
obtaining information enabling identification of a second node expected to operate in the communication system, wherein the information is obtained from a third node operating in the communications system;
subsequently receiving from the second node a first request indicating the obtained information;
based on the obtained information and the first request, determining whether the second node is a node which is expected to operate in the communication system; and
based on a result of the determination, selectively sending a second request to a fourth node operating as a Public Key Infrastructure (PKI) registration authority for the communications system, wherein the second request is for registration of the second node to facilitate acceptance of a subsequent request from the second node for processing of a certificate.

57. The method according to claim 56, wherein selectively sending the second request based on a result of the determination comprises one or more of the following:
sending the second request when the result of the determination is positive; and
when the result of the determination is negative, refraining from sending the second request and sending an alarm.

58. The method according to claim 56, wherein the obtained information comprises one or more of the following:
a first indication that identifies the second node; and
a second indication of a key assigned to the second node.

59. The method according to claim 58, wherein the obtained information further comprises a third indication of a type of the second node.

60. The method according to claim 56, further comprising:
storing the obtained information in a memory of the first node,
responsive to the second request, receiving from the fourth node a first response indicating a registration of the second node at the fourth node, and
responsive to the first response, sending to the second node a second response indicating the registration of the second node at the fourth node.

61. The method according to claim 56, further comprising:
prior to sending of the second request, obtaining from the third node a fourth indication indicating the fourth node, and
storing the obtained fourth indication in a memory of the first node.

62. The method according to claim 56, wherein at least one of the following applies:
the second node has a capability for automatically requesting certificates for a service-based interface of the second node,
the communications system is a Fifth Generation (5G) system,
the first node implements a Network Repository Function (NRF),
the second node implements one of the following network functions: Authentication Server Function (AUSF), Unified Data Management (UDM), and Unified Data Repository (UDR);
the third node is an Operations Support System (OSS) node;
the fourth node is a Registration Authority (RA) node;
the first request is an NF PKI Register Request;
the subsequent request for processing of the certificate is a certificate signing request (CSR);
the information is obtained via an encrypted interface,
the second request comprises the obtained information;
the second response comprises the following: a one-time password (OTP) issued by the fourth node, and an identifier of the fourth node; and
the identifier of the fourth node is a uniform resource identifier (URI) associated with the fourth node.

63. A computer-implemented method performed by a second node configured to operate in a communications system, the method comprising:
obtaining information enabling identification of the second node in the communications system;
subsequently sending a first request to a first node operating in the communications system, wherein the first request indicates the obtained information; and
responsive to the first request, receiving from the first node a second response indicating registration of the second node at a fourth node operating as a Public Key Infrastructure (PKI) registration authority for the communications system, wherein registration of the second node facilitates acceptance of a subsequent request from the second node for processing of a certificate.

64. The method according to claim 63, wherein the obtained information comprises one or more of the following:
a first indication that identifies the second node; and
a second indication of a key assigned to the second node.

65. The method according to claim 64, wherein the obtained information further comprises a third indication of a type of the second node.

66. The method according to claim 63, further comprising storing the obtained information in a memory of the second node.

67. The method according to claim 63, wherein:
the second response includes the following: a one-time password (OTP) issued by the fourth node, and an identifier of the fourth node; and
the method further comprises:
storing the OTP and the identifier of the fourth node in a memory of the second node,
sending to the fourth node a third request for processing of a certificate, wherein the third request includes or is sent with the OTP; and
responsive to the third request, receiving a third response comprising the certificate, wherein the third response is received from a fifth node operating in the communications system.

68. The method according to claim 63, wherein at least one of the following applies:
the second node has a capability for automatically requesting certificates for a service-based interface of the second node;
the communications system is a Fifth Generation (5G) system;
the first node implements a Network Repository Function (NRF);
the second node implements one of the following network functions: Authentication Server Function (AUSF), Unified Data Management (UDM), and Unified Data Repository (UDR);
the third node is an Operations Support System (OSS) node;
the fourth node is a Registration Authority (RA) node;
the first request is an NF PKI Register Request;
the subsequent request for processing of the certificate is a certificate signing request (CSR);
the information is obtained via an encrypted interface; and
the second response comprises the following: a one-time password (OTP) issued by the fourth node, and an identifier of the fourth node; and
the identifier of the fourth node is a uniform resource identifier (URI) associated with the fourth node.

69. A computer-implemented method performed by a third node configured to operate in a communications system, the method comprising:
sending, to a first node operating in the communications system, information enabling identification of a second node expected to operate in the communication system; and
sending to the first node a fourth indication of a fourth node operating as a Public Key Infrastructure (PKI) registration authority for the communications system,
wherein the information and the fourth indication facilitate registration of the second node at the fourth node,
wherein registration of the second node facilitates acceptance of a subsequent request from the second node for processing of a certificate.

70. The method according to claim 69, wherein the information comprises one or more of the following:
a first indication that identifies the second node; and
a second indication of a key assigned to the second node.

71. The method according to claim 70, wherein the information further comprises a third indication of a type of the second node.

72. A computer-implemented method performed by a fourth node configured to operate as a Public Key Infrastructure (PKI) registration authority for a communications system, and the method comprising:
receiving, from a first node operating in the communications system, a second request to register a second node in the communications network, wherein the second request includes information enabling identification of the second node in the communications system; and
responsive to the second request, sending to the first node a first response indicating registration of the second node at the fourth node, wherein registration of the second node facilitates acceptance of a subsequent request from the second node for processing of a certificate.

73. The method according to claim 72, wherein the information comprises one or more of the following:
a first indication that identifies the second node; and
a second indication of a key assigned to the second node.

74. The method according to claim 73, wherein the information further comprises a third indication of a type of the second node.

75. The method according to claim 72, wherein:
the first response includes the following: a one-time password (OTP) issued by the fourth node, and an identifier of the fourth node; and
the method further comprises:
receiving from the second node a third request for processing of a certificate, wherein the third request includes or is sent with the OTP; and
in response to the third request, initiating a third response to the second node by a fifth node operating in the communications system, wherein the third response includes the certificate.
